(19) United States
(12) Patent Application Publication
(10) Pub. No.: US 2008/0133580 A1
(43) Pub. Date: Jun. 5, 2008

(54) METHOD AND SYSTEM FOR PROVIDING AUTOMATED REAL-TIME CONTACT INFORMATION

(76) Inventors: James Andrew Wanless, Toronto (CA); Mark Gelman, Thornhill (CA)

Correspondence Address: RIDOUT & MAYBEE;SUITE 2400, ONE QUEEN STREET EAST, TORONTO, ON, M5C3B1, omitted

(21) Appl. No.: 11/948,587

(22) Filed: Nov. 30, 2007

Related U.S. Application Data
(60) Provisional application No. 60/861,740, filed on Nov. 30, 2006.

(51) Int. Cl. G06F 17/30

(52) U.S. Cl. 707/102; 707/E17.005

(57) ABSTRACT

A method and system for providing automated real-time updates of contact lists and instant messaging lists are described. In accordance with one embodiment, there is provided a method of generating dynamic contact information, comprising: providing two or more contact sources each comprising contact information defined for one or more contacts; generating a dynamic contact list comprising one or more electronic contact records with contact information from the contact sources in accordance with one or more rules for inclusion in the dynamic contact list, wherein the rules comprise one of both of a rule based on presence information of the contact and a rule based on location information of the contact; and transmitting the dynamic contact list to a first computing device for display thereon.

### RELATED APPLICATION DATA

The present application claims priority to provisional U.S. patent application No. 60/861,740, filed Nov. 30, 2006, which is incorporated by reference herein in its entirety.

### TECHNICAL FIELD

The present disclosure relates generally to communications, particularly to a method and system for providing automated real-time contact information, and in particular, a method and system for providing automated real-time updates of contact information from contact lists, instant messaging lists and other sources of contact information.

### BACKGROUND

Mobile telephones and other mobile voice-communication devices typically allow a user to select the name of contact they wish to call from a local contact list or electronic address book stored on the device. If more than one number is stored for a particular contact in the contact list (e.g., work, home and mobile phone numbers), the user may select the particular number they wish to call. Upon selection of the particular number to call via user input on the graphical user interface of the device, the mobile communication device may be used to directly dial the number from contact list using the user's cellular (“wireless”) network.

Contact information or contacts records in electronic address books are typically divided into three broad categories consisting of: personal contacts; global/group contacts; and instant messaging contacts or “buddies”. Conventional contact lists are static and may be out of date or otherwise not relevant to a user's current situation or needs for contact information.

Thus, there exists a need for an improved method and system for providing contact information.

### BRIEF DESCRIPTION OF THE DRAWINGS

FIG. 1 is a block diagram showing a communication system in accordance with one embodiment of the present disclosure;

FIG. 2 is a block diagram of an example mobile communication device suitable for use in the communication system of FIG. 1 in accordance with one embodiment of the present disclosure;

FIG. 3 is a block diagram illustrating data connections with the communication system of FIG. 1 in accordance with one embodiment of the present disclosure;

FIG. 4 is a block diagram of a protocol architecture for use in the communication system of FIG. 1 in accordance with one embodiment of the present disclosure;

FIG. 5 is a block diagram illustrating the relationship between the dynamic contact engine and sources of contact information in accordance with one embodiment of the present disclosure;

FIG. 6 is a block diagram illustrating the originating and terminating end points through which communications may be mediated in accordance with one embodiment of the present disclosure; and

FIG. 7 is a flowchart illustrating operations for generating a dynamic contact list in accordance with one embodiment of the present disclosure.

It will be noted that throughout the drawings similar features are identified by the same reference numerals.

### DETAILED DESCRIPTION OF EXAMPLE EMBODIMENTS

The present disclosure describes a method and system for providing automated real-time contact information, and in particular, a method and system for providing automated real-time updates of contact information from contact lists, instant messaging lists and other sources of contact information.

Traditionally contact information or contacts records in electronic address books are divided into three broad categories consisting of: personal contacts; enterprise (global) or group contacts; and instant messaging contacts or “buddies”. The present disclosure describes a method which combines these categories of contact information into a single access point which a user access to view and use for the purpose of conducting voice, email, instant messaging (IM), SMS (Short Message Service) text messaging, or MMS (Multimedia Messaging Service) messaging communications, or for locating the respective contact's physical address. Combining contact information in this manner removes any delineation between the tradition categories of contact information to the user of the interface. This information can be viewed through a Web browser on a computer or mobile device (such as a personal data assistant (PDA) or smartphone having mobile data capabilities), a standalone application on the user's computer or mobile device which provides a visual user interface and data connections (such as a Java™ application), or an interactive voice recognition (IVR) user interface where the user creates input through the use of voice recognition and the system returns results based upon input presented using text to speech voice synthesis.

Traditionally contact information is static and is only created, modified or removed manually and as such is only present in a user's contact or instant messaging list if it has manually added, modified or deleted by the user. The present disclosure provides a method by which contact information is automatically updated. Contact information is added, modified or removed from a contact list based on one or more a combination of location information about the contact, location information about the user, presence information about the contact, contact information about the contact, metadata about the contact information, date, time or a specific keyword search of the contact information in accordance with one or more rules. The contact information may be added or removed from one or more sources to an existing contact list of the user such as one or more personal contact list, enterprise or group contact list, and an IM contact list when generating a dynamic contact list in real-time from multiple contact sources.

In accordance with one embodiment of the present disclosure, a dynamic contact list is generated from contact information such as personal contact lists, group contact lists such as enterprise group lists, instant messaging (IM) buddy lists or IM presence rosters, or other sources of contact information. The dynamic contact list may be generated in accordance with one or a combination of presence information (such as IM presence rosters), location information (such as the relative geographic location of the user to the location of contacts), predefined personal and business rules, and business and user preferences. Using one or a combination of these elements, a dynamic contact list may be populated with contact records. The dynamic contact list, once populated with contact records, may be updated by adding, removing or modifying the contact records in the dynamic contact list. The dynamic contact list may present all contacts within a unified or consolidated contact list.

In accordance with one embodiment of the present disclosure, there is provided a method for a method of generating dynamic contact information, comprising: providing two or more contact sources each comprising contact information defined for one or more contacts; generating a dynamic contact list comprising one or more electronic contact records with contact information from the contact sources in accordance with one or more rules for inclusion in the dynamic contact list; and transmitting the dynamic contact list to a first computing device for display thereon.

In accordance with another embodiment of the present disclosure, there is provided a method for a method of generating dynamic contact information, comprising: providing two or more contact sources each comprising contact information defined for one or more contacts; generating a dynamic contact list comprising one or more electronic contact records with contact information from the contact sources in accordance with one or more rules for inclusion in the dynamic contact list, wherein the rules comprise one of both of a rule based on presence information and a rule based on location information; and transmitting the dynamic contact list to a first computing device for display thereon.

In accordance with a further embodiment of the present disclosure, there is provided a server configured to communicate with a plurality of computing devices over a communications network, comprising: a processor; a communications subsystem connected to the processor for exchanging signals with the communications network and with the processor; wherein the server is configured for: collecting contact information from two or more contact sources of contact information; generating a dynamic contact list comprising one or more electronic contact records with contact information from the contact sources in accordance with one or more rules for inclusion in the dynamic contact list, wherein the rules comprise one of both of a rule based on presence information and a rule based on location information; and transmitting the dynamic contact list to a first computing device.

In accordance with a further embodiment of the present disclosure, there is provided a computing device, comprising: a processor for controlling the operation of the computing device; a display screen connected to the processor; a communications subsystem connected to the processor for exchanging signals with the communications network and with the processor; and a input device connected to the processor for receiving input; wherein the computing device is configured for: receiving a dynamic contact list comprising one or more electronic contact records with contact information from the contact sources in accordance with one or more rules for inclusion in the dynamic contact list, wherein the rules comprise one of both of a rule based on presence information and a rule based on location information; and displaying the dynamic contact list on the display screen.

### System Architecture

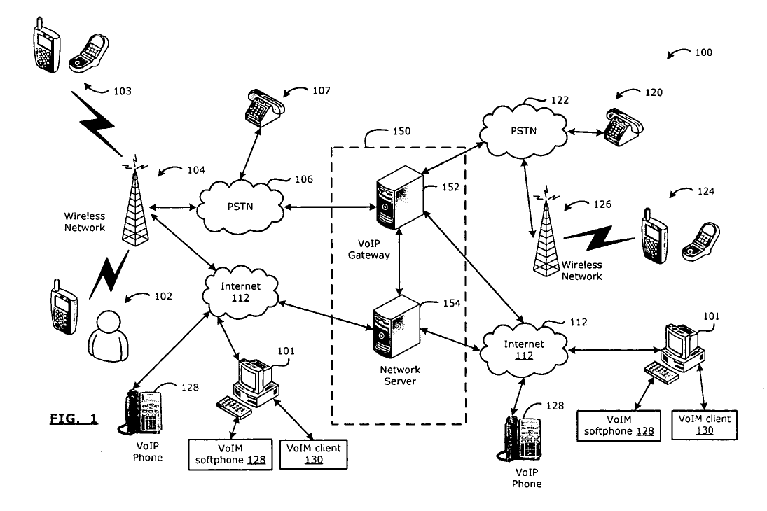

FIG. 1 is a block diagram of a communication system 100 in accordance with one embodiment of the present disclosure. The communication system 100 may be used in combination with the method and system of generating a dynamic contact list described in the present disclosure. The communication system 100 comprises a plurality of mobile communication devices 102, 103 such as mobile telephones or voice-enabled communication devices which are connected to a wireless voice and data network 104. The wireless network 104 also connects to landline telephones 107 via a public switched telephone network (PSTN) 106. The wireless network 104 comprises a wireless network gateway (not shown) which connects the mobile communication devices 102 to the Internet 112. Voice over Internet Protocol (VoIP) phones 128 and computers 101 such as personal computers or enterprise workstations are connected to the communication system 100 via the Internet 112. The computers 101 may implement software-based VoIP phones referred to as VoIP softphones 128 and/or Voice over Instant Messaging (VoIM) clients 130 for establishing voice calls. The computers 101 may be a wireless Internet appliance such as a smartphone having both voice and data capabilities.

The wireless network 104 typically comprises a wireless Wide Area Network (WAN) implemented as a packet-based cellular network that includes a number of base transceiver stations where each of the base stations provides wireless Radio Frequency (RF) coverage to a corresponding area or cell. The wireless WAN is typically operated by a cellular network service provider that provides subscription packages to users of the mobile communication devices 102. In some embodiments, the wireless WAN conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) or various other third generation networks such as EDGE (Enhanced Data rates for GSM Evolution) or UMTS (Universal Mobile Telecommunication Systems), or various other 3.5G networks such as HSPDA (High-Speed Downlink Packet Access) or 4G networks. It will be appreciated that the wireless network types described above are provided for purposes of illustration only, and are not intended to be limiting.

The communication system 100 also comprises a communication mediation subsystem 150 (sometimes referred to as a smart route dialing network or system) comprising a Voice over Internet Protocol (VoIP) gateway 152 and a network server 154 which are connected with each other. The VoIP gateway 152 is typically implemented using software. The features of the VoIP gateway 152 may be integrated with those of the network server 154 even though they may be described as separate components. The communication mediation subsystem 150, as part of its functions, establishes and manages voice connections between callers during a voice call.

The VoIP gateway 152 is connected to the wireless network 104 via the PSTN 106, and to the Internet 112 via the network server 154. Landline telephones 107 connect to the VoIP gateway 152 via the PSTN 106. The VoIP gateway 152 is also connected to other PSTNs 122, to other wireless networks 124 via the PSTNs 122, to VoIP phones 128 and VoIP networks (not shown) over the Internet 112, and to Voice over Instant Messaging (VoIM) clients 130 running on computers or other computing devices (such as suitable equipped mobile telephones) via VoIM networks (also referred to Instant Messaging (IM) voice networks) over the Internet 112.

The computers 101 typically comprise a processor (i.e., microprocessor) for controlling its operation, a communications subsystem connected to the processor for communicating with the communications system 100, a display screen or monitor connected to the processor, one or more user input devices such as a keyboard and mouse connected to the processor for sending user input signals to the processor in response to user inputs, a memory or storage element s connected to the processor such as a hard disk drive (HDD), RAM, ROM and/or other suitable memory connected to the processor, and other suitable input and output devices (not shown) as desired or required. The memory has data and instructions stored thereon for configuring the processor and computer 101. Operating system software, software applications, and data used by the processor are stored in the memory. The applications and data configure the operation of the computer 101. Other features of the computer 101 for implementing the processes and functions described herein will be appreciated by persons ordinarily skilled in the art.

The VoIP phones 128 may be hardware-based, SIP-enabled VoIP phones (sometimes referred to as Internet Phones or Digital Phones) such as those provided by Nortel Networks Corporation and Cisco Systems, Inc., or software-based phones referred to as VoIP softphones (sometimes referred to as SIP clients, SIP softphones). Instead of a hardware-based VoIP phone, an analog telephone may be used in combination with a VoIP analog telephone adapter. The VoIP softphones may be implemented on computers 101 or suitable equipped mobile telephones with an SIP client (such as Nokia™ E and N series mobile telephones, or mobile telephones running Windows Mobile™ version 6). Example VoIP softphones are provided by CounterPath Solutions, Inc. (http://www.counterpath.com) and SJ Labs, Inc. (http://www.sjlabs.com).

The VoIP gateway 152 receives incoming voice calls from landline telephones 107 and mobile communication devices 102 via the PSTN 106. The VoIP gateway 152 also receives incoming voice calls from VoIP phones 128 and VoIM clients 130 via the Internet 112.

At least some of the mobile communication devices 102 and computers 101 are provided with a suitable Internet browser such as Internet Explorer™ from Microsoft Corporation and/or a Java™ Runtime Environment (JRE) and Java™ application or applet installed on the computer 101 for accessing a graphical user interface (GUI) of a communication mediation subsystem 150 of the communication system 100. Users access the GUI using the Internet browser or Java™ application. If a computer 101 is equipped with a VoIP softphone 128 or VoIM client 130, the computer 101 may be used to connect a voice call. If the computer 101 does not have these capabilities, then a call back or call-in telephone must be used to connect to the voice call using a call back or call-in telephone number.

A call back telephone is a telephone at which the VoIP gateway 152 will call the calling party. The call back telephone may also be a software based voice client such as a VoIP softphone 128 or VoIM client 130. Using the computer 101 or mobile communication device 102, the calling party instructs the VoIP gateway 152 to initiate an outbound ball to the specified call back telephone number or other identifier, and to route and connect the voice call to the destination identifier (i.e., destination landline or mobile telephone number, SIP URI, or IM address) once the outbound call has been answered on the call back telephone. The call back telephone may be a mobile phone, a landline or PSTN phone (such as the user's home or office telephone), a VoIP phone or softphone 128, or VoIM client 130.

A call-in telephone is the telephone from which a calling party will call the VoIP gateway 152. The call-in telephone may also be a software based voice client such as a VoIP softphone 128 or VoIM client 130. Using a computer 101 or mobile communication device 102, the calling party instructs the VoIP gateway 152 that it will receive an inbound call from a specified call-in telephone number or other identifier, and to route and connect the voice call to the destination identifier (i.e., destination landline or mobile telephone number, SIP URI, or IM address) once the inbound call has been received from the call-in telephone number. The call-in telephone may be a mobile phone, a landline or PSTN phone (such as the user's home or office telephone), a VoIP phone or softphone 128, or VoIM client 130.

For example, a voice call may be setup using the Internet browser on the computer 101, and connected using a desk phone adjacent to the computer 101 using a call back or call-in function. Alternatively, the call could be connected using the user's mobile telephone using a call back or call-in function. In the above examples, the telephone number of the desk phone or mobile telephone is provided as the call back or call-in telephone number to the communication mediation subsystem 150 using the GUI presented in the Internet browser. The technical capabilities of computers 101 required to perform the above-described functions will be readily apparent to persons ordinarily skilled in the art and will not be described herein.

The use of call-in and call back functions may be advantageous for several reasons. The call back and call-in functions allow users to use computers 101 to connect to the communication mediation subsystem 150 via its GUI. This may be advantageous where users do not have a mobile telephone with the required technical capabilities for connecting to the GUI (i.e., telephones which lack a Web browser and/or which lack the technical capabilities to execute Java™ applications/applets) to use the communication mediation subsystem 150. The use of call-in and call back functions may also result in lower costs for the voice call. For example, the cost of a calling from a given telephone (such as a mobile communication device 102) may be different than the cost of receiving a call on the same telephone depending on the rates charged by the respective carriers associated with the call. The costs may also vary between two different telephones or voice clients, for example, between a mobile communication device 102, a landline phone 107, and a VoIP phone 128 or VoIM client 130. Additionally, the computing device on which a user selects to access the GUI of the communication mediation subsystem 150 may not be a computer which is not equipped to handled voice calls (i.e., it may not have a VoIP phone 128 or VoIM client 130), in which case a call back and call-in is required.

The VIP gateway 152 is connected to the PSTN 106 via a VoIP switch (not shown) which performs translation and negotiation functions for transforming voice data passed through the PSTN 106 into digital voice data packets, receiving voice data packets from SIP-compatible VoIP phones and networks, and translating voice data packets between different VoIP protocols if required. Suitable VoIP switches are known in the art such as those provided by Nortel Networks Corporation and Cisco Systems, Inc. Thus, the VoIP gateway 152 receives voice data from the landline telephones 107 and mobile communication devices 102 in the form of SIP-compatible VoIP voice data packets via the VoIP switch.

The VoIP gateway 152 routes and connects calls to destination identifiers corresponding to landline telephones 120 via a PSTN 122. Calls to destination identifiers corresponding to mobile communication devices 124 are routed and connected via a wireless network 126 using an intermediary PSTN such as the PSTN 122. The VoIP gateway 152 also routes and connects calls to destination identifiers corresponding to instant messaging (IM) identities (i.e., using IM addresses) to computers or other computing devices running VoIM clients 130 via the Internet 112, and to destination identifiers corresponding to SIP URIs (Session Initiation Protocol Uniform Resource Identifiers) to VoIP phones 128 via the Internet 112.

The VoIP gateway 152 is configured to implement least cost routing (LCR) for calls placed from originating mobile communication devices 102 and landline telephone 107 and/or to destination landline telephones 120 and mobile communication devices 124. Intelligent least cost routing techniques are known in the art and will not be described in detail herein. Any suitable least cost routing method may be used by the VoIP gateway 152. The VoIP gateway 152 uses least cost routing to select the most cost-effective routing/connection path from the originating communication device to the destination identifier. For mobile communication devices 102, the home location and current location of the mobile communication devices 102 may be used in determining the least cost route. Typically, rate information for the various carriers is stored in an internal routing table. This rate information is typically compared against call quality information (which may also be stored in the routing table or in a separate routing table) so as to select a routing for the call which is cost effective but which will have an acceptable level of call quality or reliability.

The network server 154 may be implemented as one or more server modules and may be located behind a firewall (not shown). The network server 154 provides at least HTTP (Hypertext Transfer Protocol) and SIP (Session Initiation Protocol) connectivity. The current SIP standard is defined by Request for Comments (RFC) 3261; however the present disclosure is intended to cover all revisions, supplements, additions and replacements to this standard, whether or not explicitly described herein. The network server 154 functions as an Internet/Web server and/or application server for receiving and responding to requests from the mobile communication devices 102 or computer 101 via a suitable Internet browser such as Internet Explorer™ from Microsoft Corporation and/or a Java™ application or applet (Java™ is a trade-mark of Sun Microsystems, Inc.).

The network server 154 also functions as an SIP server for establishing an SIP session/connection with VoIP phones 128 and/or VoIP networks. As will be appreciated by persons skilled in the art, SIP is a peer-to-peer application-layer control (signaling) protocol for creating, modifying, and terminating sessions with one or more participants (i.e., for VoIP calls in this instance). Other supporting protocols are used for transmitting data during an SIP communication session after the session has been created. Session Description Protocol (SDP) describes streaming media initialization parameters for the purposes of session announcement, session invitation, and other forms of multimedia session initiation. The current SDP standard is defined by RFC 4566. The SIP sessions may be packet streams of the Real-time Transport Protocol (RTP) data carrying voice data packets. The current RTP standard is defined by RFC 3550.

Although reference has been made to particular versions of the SIP standard/protocol and some of its supporting standards/protocols, this is for the purpose of explanation only and is not intended to be limiting. It will be appreciated that the innovations described herein are intended to cover all revisions, supplements, additions and replacements to the SIP standard/protocol and its supporting standards/protocols.

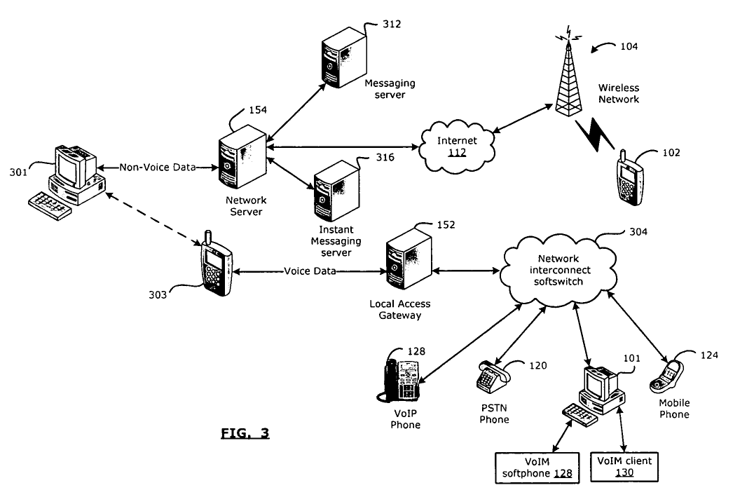

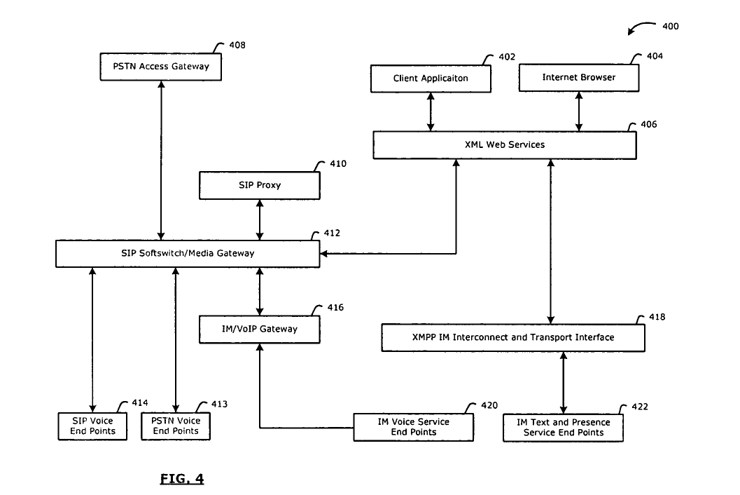

The network server 154 also implements a network interconnect softswitch 304 (FIG. 3) which interconnects and performs switching functions between the various PSTNs, VoIP, and VoIM connections to the VoIP gateway 152. The network interconnect softswitch 304 will be described in more detailed below in connection with FIGS. 3 and 4.

The network server 154 may be implemented using any suitable computer. Typically, the server computer comprises a processor (i.e., microprocessor) for controlling its operation and a communications subsystem connected to the processor for communicating with the communications network and various end points. The server computer may further comprise a display screen or monitor connected to the processor, one or more user input devices such as a keyboard and mouse connected to the processor for sending user input signals to the processor in response to user inputs, a memory or storage element s connected to the processor such as a hard disk drive (HDD), RAM, ROM and/or other suitable memory connected to the processor, and other suitable input and output devices (not shown) as desired or required. The memory has data and instructions stored thereon for configuring the processor and network server 154. Operating system software, software applications, and data used by the processor are stored in the memory. The applications and data configure the operation of the network server 154. Other features of the network server 154 for implementing the processes and functions described herein will be appreciated by persons ordinarily skilled in the art.

After the VoIP gateway 152 determines the optimal route for outgoing call using least cost routing, the network interconnect softswitch 304 connects the call to the appropriate voice end point (via PSTNs/wireless networks, VoIP, and VoIM) according to the type of connection and the selected destination identifier for the outgoing call. The outgoing call may be directed to a landline telephone 120 via a PSTN 122, a mobile communication devices 124 via the wireless network 126/PSTN 122), a VoIP phone 128 via the Internet 112, or to a VoIM client 130 on a computer or other computing device via the Internet/VoIM network.

The network server 154 is also connected to a user account database (not shown) which stores data user account details such as user identifiers (ID), passwords or passcodes (i.e., PINs), and user preferences. The user account database may also store one or more user contact lists. User preferences and settings may be stored on the network server 154 so that the settings are available from any computer 101 or mobile communication devices 102. User preferences typically include the user's current location (for example, in terms of the country and area code/city code (if any), the conditions under which the VoIP gateway 152 will connect outgoing calls (for example, all, none, or long distance), the conditions under which the user's cellular or other wireless carrier network will connect outgoing calls, whether a call back or call-in number should be used, a call back number, and a call-in number (which may be the same as the call back number). If the user's cellular carrier is used for connecting outgoing calls, the communication mediation subsystem 150 provides a centralized, online contact list and call dialing service, but does not connect or route calls or provide least cost routing services.

User preferences may also include caller identification (ID) settings. The caller ID setting allows the telephone number or other identifier which is displayed on the telephone of the called party, or within the voice client (i.e., VoIP softphone 128 or VoIM client 130) of the called party to be set to a number specified in the caller ID settings. For example, the caller ID settings may provide the option to display the user's mobile telephone number, business telephone number, a follow-me number, or any other number provided by the user. A caller name may also be provided and displayed to the called party along with the specified telephone number. Alternatively, the caller ID settings may allow the caller number and/or name to be displayed as “private”. As will be appreciated by persons of ordinary skill in the art, a follow-me number is a phone number that, when called, is terminated onto a unified messaging or PBX (Private Branch exchange) system which then does a lookup based on a set of user defined preferences to determine where the call should be forwarded to. These preferences can determine the number or other destination identifier to which a voice call should be forward in accordance with factors such as the time of day, day of the week, etc. or the identity of the person making the call.

It will be appreciated that the system 100 shown in FIG. 1 is illustrative of a suitable communication system for implementing the voice call connection method of the present disclosure, and that other configurations are possible. Although some communication networks such as the wireless networks 104, 126 and PSTNs 106, 122 have been represented as separate networks, it will be appreciated that in some embodiments and/or in some use case scenarios, one or more of the networks of each respective type may be the same. Furthermore, although individual system components are shown, it will be appreciated by persons of ordinary skill in the art that certain system components may have multiple instances, for example a plurality of local access (VoIP) gateways may be used to cover predefined geographic regions. In addition, each VoIP gateway 152 may be connected to a plurality of PSTNs, VoIM networks and wireless networks.

### Example Mobile Communication Device

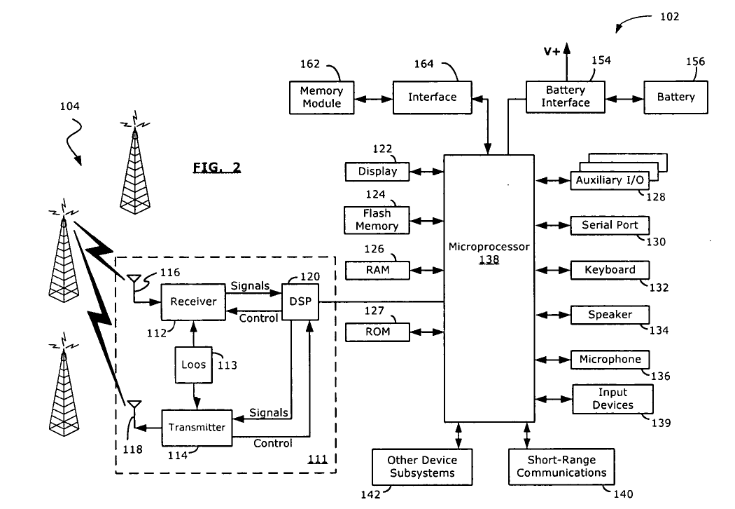

FIG. 2 is a block diagram of an example mobile communication device 102 suitable for connecting to the communication system 100, and which may be used in combination with the method and system of targeted advertising described in the present disclosure. The mobile communication device 102 is a two-way communication device having data and voice communication capabilities, and the capability to communicate with other computer systems, for example, via the Internet. Typically, the mobile communication device 102 is a handheld device such as a mobile telephone.

The mobile communication device 102 comprises a microprocessor 138 which controls the overall operation of the mobile communication device 102 and a communication subsystem 111 connected to microprocessor 138 for exchanging radio frequency signals with the wireless network 104. Communication functions, including at least voice and data communications, are performed through communication subsystem 111. The communication subsystem 111 comprises at least a WAN communication subsystem for two-way communication with the wireless WAN and passably a wireless local area network (WLAN) communication subsystem two-way communication with a WLAN via the access points. The communication subsystem 111 comprises includes a receiver 112, a transmitter 114, and associated components, such as one or more antenna elements 116 and 118 (which may are commonly embedded or internal), local oscillators (LOs) 113, and a processing module such as a digital signal processor (DSP) 120. As will be apparent to those skilled in the field of communications, the particular design of the communication subsystem 111 depends on the wireless network 104 in which mobile communication device 102 is intended to operate.

The mobile communication device 102 may communicate with any one of a plurality of fixed transceiver base stations of the wireless network 104 within its geographic coverage area. The mobile communication device 102 may send and receive communication signals over the wireless network 104 after the required network registration or activation procedures have been completed. Signals received by the antenna elements 116 and 118 through the wireless network 104 are input to the receiver 112, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 120. In a similar manner, signals to be transmitted are processed, including modulation and encoding, for example, by DSP 120. These DSP-processed signals are input to the transmitter 114 for digital-to-analog (D/A) conversion, frequency up conversion, filtering, amplification and transmission over the wireless network 104 via the antenna 118. The DSP 120 not only processes communication signals, but also provides for receiver and transmitter control. For example, the gains applied to communication signals in the receiver 112 and the transmitter 114 may be adaptively controlled through automatic gain control algorithms implemented in the DSP 120.

Network access is associated with a subscriber or user of the mobile communication device 102 via a memory module 162, such as a Subscriber Identity Module (SIM) card for use in Global System for Mobile communications (GSM) networks, a Removable User Identity Module (RUIM) card for use in CDMA2000 (Code Division Multiple Access 2000) networks, or a Universal Subscriber Identity Module (USIM) card for use in UMTS (Universal Mobile Telephone Systems) networks, to be inserted in or connected to an interface 164 of the mobile communication device 102 in order to operate in the wireless network 104. Other memory modules supporting other wireless networks types may also be used. Alternatively, the memory module 162 may be a non-volatile memory which is programmed with configuration data by a service provider so that the mobile communication device 102 may operate in the wireless network 104.

The mobile communication device 102 also includes a battery interface 154 for receiving one or more rechargeable batteries 156. The battery 156 provides electrical power to the electrical circuitry in the mobile communication device 102, and the battery interface 154 provides a mechanical and electrical connection for it. The battery interface 154 is coupled to a regulator (not shown) which provides power V+ to the circuitry of the mobile communication device 102.

The microprocessor 138 is also connected to additional device subsystems such as a display 122 which may be a backlight light emitting diode (LED) screen or liquid crystal display (LCD) screen, a flash memory 124, a random access memory (RAM) 126, a read-only access memory (ROM) 127, auxiliary input/output (I/O) subsystems 128, a data port such as serial port 130, a keyboard or keypad 132, a speaker 134, and a microphone 136, one or more other user input devices 139 such as a navigation or directional pad, a touch screen, a clickable trackwheel (thumbwheel) or trackball, a short-range communications subsystem 140, and any other device subsystems generally designated at 142.

The microprocessor 138 operates under stored program control and executes computer programs or code modules stored in memory such as persistent memory such as the flash memory 124. The memory has data and instructions stored thereon for configuring the processor and mobile communication device 102. The computer programs or code modules comprise two general categories of software: operating system software and software applications. Those skilled in the art will appreciate that the operating system, specific device applications, or parts thereof, may be temporarily loaded into volatile memory such as the RAM 126. The RAM 126 is used for storing runtime data variables and other types of data or information, as will be apparent to those skilled in the art.

The mobile communication device 102 is provided with a graphical user interface (GUI) for controlling the operation of the device. Other applications may be preloaded on the mobile communication device 102 for use via the GUI. The mobile communication device 102 is provided with an Internet/Web browser such as Internet Explorer™ from Microsoft Corporation or other suitable browser. In some embodiments, the mobile communication device 102 is provided a Java™ Runtime Environment (IRE), also known as the Java™ Virtual Machine, for running Java™ applications. Additional applications may be subsequently loaded onto the mobile communication device 102 via download over the wireless network 104, the auxiliary I/O subsystem 128, the serial port 130, the short-range communications subsystem 140, or any other suitable subsystem 142, and installed by a user in RAM 126 or persistent store such as flash memory 124 for execution by the microprocessor 138.

The mobile communication device 102 may also include a personal information manager (PIM) application having the ability to organize and manage data items relating to user such as, but not limited to, instant messaging, email, calendar events, contacts, voice mails, appointments, and task items. The PIM application has the ability to send and receive data items via the wireless network 104. The functions of the PIM application may also be provided via one or more separate program applications.

The short-range communications subsystem 140 provides for communication between the mobile communication device 102 and other systems or devices. The short-range communications subsystem 140 may comprise an infrared transceiver and/or a Bluetooth® communication module for communication with similarly-enabled systems and devices (Bluetooth® is a registered trademark of Bluetooth SIG, Inc.).

### Connections and Communications Architecture

Referring now to FIGS. 3 and 4, the data connections and communications architecture of the communication system 100 will now be described. FIG. 3 is a block diagram illustrating the data connections between a computing device 301 for connecting to the GUI of the communication mediation subsystem 150 of the communication system 100, and a voice-enabled communication device 303 for establishing a voice call in accordance with one embodiment of the present disclosure. The computing device 301 may be a personal computer 101 or a handheld mobile communication device 102 having at least data capabilities such as a smartphone. The communication device 303 may be a telephone or voice client such as a PSTN or landline telephone 107, mobile telephone 102, VoIP phone 128, or a VoIM client 130. Voice and non-voice data streams have been shown separately for purpose of illustration, however these streams may occur together in the communication system 100. The computing device 301 and communication device 303 may be the same or different devices. For example, a mobile communication device 102 having both voice and data capabilities or a computer 101 having a VoIP softphone 128 or VoIM client 130 for establishing the voice call may be used to provide the functionality of the computing device 301 and communication device 303 described herein.

Voice data is transmitted between the communication device 303 and a local access VoIP gateway 152 via a PSTN (not shown). The VoIP gateway 152 is connected to a network interconnect softswitch 304 which interconnects and performs switching functions between the various PSTNs, VoIP, and VoIM connections to the VoIP gateway 152. The network interconnect softswitch 304 connects voices call from the communication device 303 to the appropriate end point according to the type of connection and the relevant destination identifier for the voice call. An outgoing voice call may be connected to a landline telephone 120 via a PSTN 122, a mobile communication device 124 via the wireless network 126/PSTN 122, a VoIP phone 128 via the Internet 112, or a VoIM client 130 on a computer 101 or other computing device via the Internet 112 and the respective VoIM network.

Non-voice data is transmitted between the computing device 301 and the network server 154. Instant messaging text and presence information and other data, such as emails, Short Message Service (SMS) messages, Multimedia Messaging Service (MMS) messages, may be transmitted between the computing device 301 and the network server 154, and from the network server 154 to the appropriate end point such as a messaging server 312 for emails sent to an email address (for example, a Microsoft Exchange™ server), a wireless data network 104 for SMS and MMS messages sent to a mobile telephone 102, and an instant messaging server 316 for IM text and presence information sent to an IM client or VoIM client. Intermediary networks and connections have not been shown for purposes of simplicity.

Thus, it will be appreciated that three data streams may be generated: (1) a voice data stream for transmitting voice data packets compatible with SIP, including VoIP voice data packets and non-VoIP voice data packets encoded in accordance with IM network proprietary encoding protocols which are compatible with SIP; a (2) data stream for transmitting text and presence information between the system and respective IM networks; and a (3) data stream for transmitting other data such a SMS (Short Messaging System) and MMS (Multimedia Messaging System) messages.

FIG. 4 is a block diagram of the communications architecture 400 used in the communication system 100 for mediating voice and text communications in accordance with one embodiment of the present disclosure. A user may access the communication mediation subsystem 150 via a graphical user interface (GUI) displayed on a computing device, such as a computer 101 or mobile communication device 102 having data functionality. The GUI may be provided via an Internet browser 404, such as Internet Explorer™, presenting an eXtensible HyperText Markup Language (XHTML) document or a Java™ application or applet 402. The Internet browser 404 and client application 402 receive data from XML (eXtensible Markup Language) Web services 406 which are connected to an SIP Softswitch/Media Gateway 412 and an XMPP (eXtensible Messaging Presence Protocol) Instant Messaging (IM) Interconnect and Transport interface 418. The XMPP IM Interconnect and Transport interface 418 connects to IM text and presence service end points 422 of the IM networks/services which have agreed to share IM text communications and/or presence information and with the communication mediation subsystem 150. Separate presence services may also connect to the communication mediation subsystem via the XMPP IM Interconnect and Transport interface 418.

Through the above-described connections, instant messaging text and presence information may be provided to the user via the GUI. It will be appreciated that the IM text communications and presence information do not originate with the communication mediation subsystem 150, but are provided to the communication mediation subsystem 150 by respective IM networks and re-transmitted to GUI on the user's mobile communication device 102 or computer 101. The communication mediation subsystem 150 relays instant messaging text and presence information in accordance with defined rules and preferences as explained in more detail below.

The network server 154 is connected to, or comprises a number of functional modules, comprising an SIP proxy server 410, an SIP Softswitch/Media Gateway 412, and an IM/VoIP gateway 416. These elements comprise the network interconnect softswitch 304 previously described in relation to FIG. 3.

The SIP proxy server 410 connects users to the communication mediation subsystem 150 using an SIP client on the computing device. The SIP proxy server 410 establishes SIP sessions between the computing device and VoIP phones 128 and other SIP clients. If a voice call is connected to a softswitch through a gateway and then to a VoIP end point (SIP URI) then the SIP proxy server 410 establishes an SIP session between the SIP Softswitch/Media Gateway 412 and VoIP phone/client 128, and not between the mobile communication device 102 and the VoIP phone/client 128.

The SIP Softswitch/Media Gateway 412 is connected to the SIP proxy server 410. The SIP Softswitch/Media Gateway 412 performs two primary functions. The first function is SIP session setup to establish the route for communications. The second function is media transport. Media transport is typically performed in the case that either one of the end points is behind a Network Address Translation (NAT) firewall, or the compression algorithm used for the media stream is different between the originating and destination end points (for example, the call starts as G.729a and ends as G711 or GSM). The SIP session is comprised of signalling and media data streams. As noted above, the media stream typically conforms to the Real-time Transport Protocol (RTP). RTP data can often pass peer-to-peer in the case that each end point has an external IP address and is transmitting the RTP data using the same compression algorithm.

The SIP Softswitch/Media Gateway 412 connects all types of end points to the communication mediation subsystem 150. The SIP Softswitch/Media Gateway 412 connects to a PSTN access gateway 408 and PSTN termination end points 413 (such as landline/PSTN phones 120, and mobile phones 124 via wireless networks 126 connected to PSTNs) for transmitting voice data between originating telephone or voice client and the PSTN voice end points 413. The PSTN access gateway 408 comprises a number of local access gateways to which calling parties may connect to the system 100 via a PSTN telephone 107 or mobile communication device 102 using a direct call, call-in or call back when conducting a voice call. The SIP Softswitch/Media Gateway 412 is also connected to the SIP voice termination end points 414 (i.e., SIP-based VoIP phones 128) for transmitting voice data between the SIP voice end points and the originating telephone or voice client.

The SIP Softswitch/Media Gateway 412 is also connected to the IM/VoIP gateway 416. The IM/VoIP gateway 416 connects calling parties to called parties using VoIM clients 130. Each IM network may use its own proprietary media encodation protocol. If a proprietary media encodation protocol is used, outgoing voice data packets of the VoIP gateway 152 are transcoded to generate voice data packets which are compatible with the proprietary protocol of the destination IM/VoIM network in order for a voice call to be passed between the originating telephone or voice client and the destination VoIM client 130.

The IM/VoIP gateway 416 comprises a transcoder which transcodes SIP-compatible voice data packets received from the VoIP gateway 152 into VoIM voice data packets that are compatible with the respective VoIM networks in accordance with the respective VoIM network encodation protocol. After transcoding the SIP-compatible voice data packets into a format that is compatible with the respective VoIM network, the transcoded voice data packets are transmitted to the respective VoIM network.

The transcoder of the IM/VoIP gateway 416 also transcodes VoIM voice data packets received from the respective VoIM networks in the proprietary encodation protocols into SIP-compatible voice data packets suitable for the VoIP gateway 152. After transcoding the VoIM voice data packets into SIP-compatible voice data packets, the transcoded SIP-compatible voice data packets are transmitted to the respective VoIP gateway 152, and from the VoIP gateway 152 to the originating telephone or voice client. If the encodation of the voice data packets of the different VoIM networks is the same (for example, if a standard for VoIM voice data packets is achieved), the transcoding step may be omitted when transmitting voice data packets between VoIM clients 130 provided that standard voice data packets are used by the communication mediation subsystem 150 and the respective VoIM networks.

### Dynamic Contact List Generation

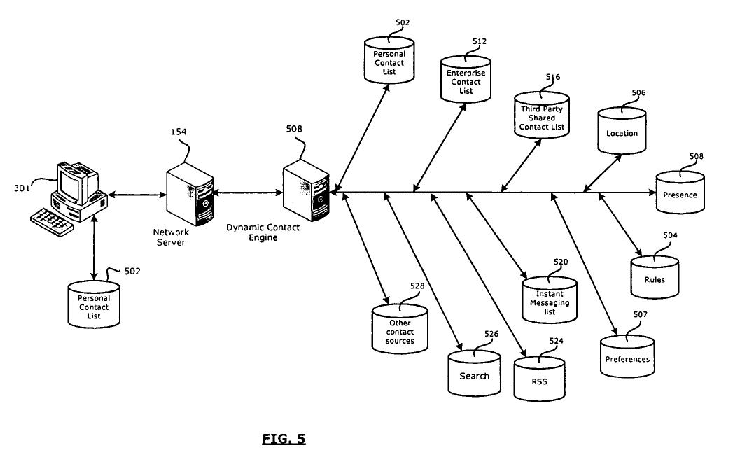

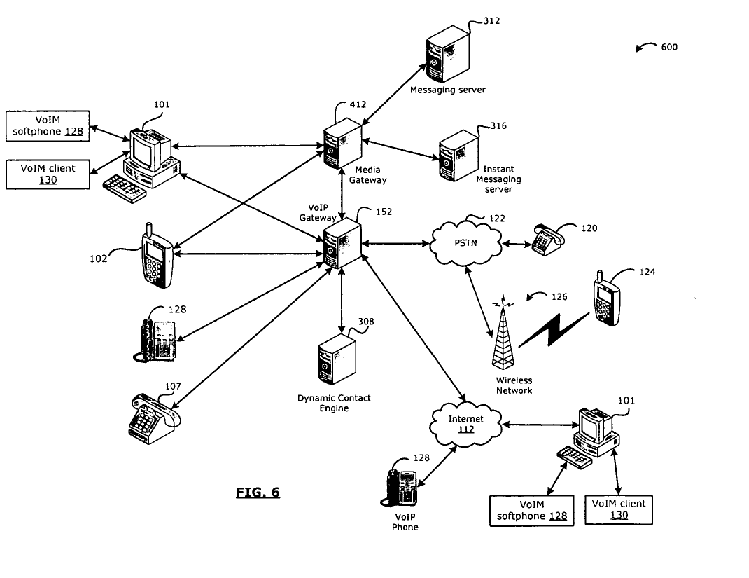

Referring now to FIGS. 5 and 6, features of a communication system 600 for generating a dynamic contact list in accordance with one embodiment of the present disclosure will be described. The communication system 600 is similar to the system 100 and incorporates a communication mediation subsystem 150 but further comprises a dynamic contact engine 510 for generating a dynamic contact list. FIG. 5 illustrates the relationship between the dynamic contact engine 510 and sources of contact information (referred to as contact sources). FIG. 6 illustrates originating and terminating end points through which communications may be mediated using the system 600.

The dynamic contact engine 510 is connected to the network server 154. Alternatively, the dynamic contact engine 510 may be implemented as part of the network server 154. Users connect to the dynamic contact engine 510 via a computing device 301 which provides a graphical user interface (GUI). The computing device 301 connects to the dynamic contact engine 510 through the network server 154 via the Internet 112 or other communications network. The GUI may be a web-based portal provided via a series of web pages in an Internet browser 404 or client application 402 on the computing device 301. The client application 402 may be a Web application implemented using Java™ (i.e., a Java™ application or applet) or other suitable programming language. The computing device 301 may be a personal computer 101, an Internet enabled handheld mobile communication device 102 such as mobile telephone, personal digital assistant (PDA), or smartphone, or a navigation device such as a GPS device through an application installed on any of these devices where the application provides a visual user interface in place of the Internet browser 404. Additionally a subset of this information may be accessible through a voice user interface (not shown) where a visual user interface is not available, such as when using a mobile communication device 102 but where data network capabilities are temporarily unavailable rendering the Internet browser 404 unusable. The voice user interface is typically an interactive voice recognition (IVR) user interface where the user creates input through the use of voice recognition and the system returns results based upon input presented using text to speech voice synthesis. Suitable IVR systems are known in the art and will not be described herein. The underlying functionality of the system 600 is the same, except that voice input by the user replaces input via input devices of the computing device 301 (i.e., keyboard, mouse, trackwheel, trackball or touch screen), and that audio announcements via text to speech voice synthesis replace the GUI on the computing device 301.

The dynamic contact engine 510 collects contact information from a number of sources of contact information along with location information and presence information, and generates a dynamic contact list from the contact information in accordance with one or more rules for inclusion in the dynamic contact list. The dynamic contact list comprises one or more electronic contact records with contact information from the contact sources. The rules for inclusion in the dynamic contact list may be based one or a combination of contact information, metadata about the contact information (for example, a relationship between the user and the contact, or a classification or type of the contact), presence information and location information. Generating the dynamic contact list may comprise determining contacts in the contact sources which match the rules for inclusion in the dynamic contact list, and populating the dynamic contact list with electronic contact records for contacts which match the rules.

The sources of contact information may comprises contact records from one or a combination of a personal contact list, a group contact list such as an enterprise group list which may comprises individual contacts and user groups, an instant messaging (IM) buddy list or IM presence roster, or other sources of contact information. More than one source of contact information of each type may be used.

In at least some embodiments, generating the dynamic contact list comprises: determining contacts in the contact sources which match the rules, populating the dynamic contact list for contacts from one or both of a personal contact list 502 and an enterprise contact list 512 (i.e., internal resources), and then further populating the dynamic contact list with electronic contact records for contacts in the contact sources which match the rules. In this way, the dynamic contact engine 510 adds contacts from contacts sources such as a third party contact list 516 (i.e., external resources), an IM list 520, and other contact sources.

The dynamic contact list, once populated with contact records, may be updated by adding, removing or modifying the contact records in the dynamic contact list based on changes in presence information, location information (about the user or the contacts), or contact information of the contacts in dynamic contact list. The dynamic contact list may present all contacts records within a unified or consolidated contact list with the GUI of the computing device 301.

### Contact Information

The contact sources from which the dynamic contact engine 510 collects contact information may comprise one or more of a personal contact list 502, an enterprise contact list 512, a third party contact list 516, an instant messaging (IM) list 520 from an IM network, RSS (Really Simple Syndication) content 524, searches 526, and other contact sources 528.

The personal contact list 502 (or address book) comprises personal electronic contact records of the user. The personal contact list 502 may be stored locally in the memory of the computing device 301, by the communication mediation subsystem 150 for access by the dynamic contact engine 510, and/or by an enterprise messaging server 312 (FIG. 6). The personal contact list 502 may be provided by the user or synchronized with a contact list maintained by a messaging server 312 (FIG. 6). Synchronization of the personal contact list 502 ensures that the contact information is regularly updated.

The enterprise contact list 512 (or address book) comprises electronic contact records associated with an enterprise or enterprise network of the computing device 301 or the user. Typically, the enterprise contact list 512 belongs to a corporation or other organization of which the user is a member (for example, the user's employer). The enterprise contact list 512 is a global contact list of all users and other contacts of the respective enterprise. The enterprise contact list 512 may be provided by an IT (information technology) administrator of the enterprise (i.e., corporation or other organization) or synchronized with an enterprise contact list maintained by an enterprise messaging server 312 (FIG. 6). Synchronization of the enterprise contact list 512 ensures that the contact information is regularly updated.

The third party contact list 516 comprises electronic contact records of one or more third party individuals or organization such as a business or other organization which chooses to make their contact information available to users of the communication system 600. The third party contact list 516 provides third party businesses with a mechanism to attract individuals (i.e., users of the system 600) who may interested in the goods or services offered by the business. The users may be existing customers of the business or visitors to a specific location. Third party businesses may be a hotel, restaurant, entertainment provider (i.e., theatre), taxi or limousine service, airlines, valet, business centre/printing service, tourist place of interest, or any other entity.

Using a set of one or more rules, the third party contact information may be selected for inclusion in the dynamic contact list based on contextually relevant information. For example, third party contact information may be selected based on the user's current location (i.e., if the user is the same city as the third party or within a predetermined proximity of the third party) and time (i.e., if the business is open). The selected third party contact information may be automatically populated into the user's contact list or address book and/or instant messaging list or presence roster, dependent on the type of contact information available (i.e., if contact record for a contact list or IM contact is available for the third party).

The instant messaging (IM) list 520 is a list of IM contacts or buddies in IM networks which have agreed to share IM contact and presence information with the system 600 and the dynamic contact engine 510. Typically, the respective IM user must agreed to share IM contact and presence information for each of their IM identities in the various IM networks sharing information with the system 600. At least presence information 521 and possibly location information 523 are provided by the respective IM networks for each IM contact who has agreed to share IM contact and presence information with the user and/or system 600.

The RSS content 524 comprises contact information from one or more Web sources of contact information which is periodically updated (such as a Web blog, for example). As will be appreciated by persons skilled in the art, RSS is a family of Web feed formats used to publish updated content. The RSS content 524 may be an RSS Web feed or channel which has been subscribed to by the dynamic contact engine 510 (i.e., by its administrator), or the user or user's associated enterprise. The RSS Web feed may be either a summary of content from the associated web site or the full text. Alternatively, the RSS content 524 may be provided by an RSS reader or aggregator (not shown) which checks the subscribed feeds periodically for new content, downloads any updates, consolidates this information, and stores the information for retrieval. The RSS reader may be implemented by the dynamic contact engine 510 or network server 154, or Web application server. The RSS content 524 is typically provided using eXtensible Markup Language (XML).

The searches 526 may be Internet searches using Internet search engines such as Google™, Yahoo!™ and MSN™ or local enterprise intranet searches. The searches 526 may search specialized contact sources or other resources. It will be appreciated that searches 526 are conducted through the GUI of the system 600 and so rules 504 and stored business and personal (user) preferences 507 may be used in generated the dynamic contact list, i.e. to displayed third party contacts such as businesses based on preferences such as a preferred customer relationship.

The other contact sources 528 may be specialized contact sources such as electronic (online) industry contact sources, for example restaurant guides, entertainment guides or other research guides, for providing listings of merchants or service providers with associated contact information.

### Presence Information

The dynamic contact engine 510 may also collect presence information 508 relating to users of the communication mediation subsystem 150 and contacts in the contact sources described above. In at least some embodiments, the dynamic contact engine 510 may consolidate and manage presence information 508 from multiple presence sources.

The presence information 508 may be obtained from one or more of a number of sources of presence information including instant messaging (IM) presence servers, non-IM presence servers, presence information stores or other sources of presence information. At least some of the IM presence servers may be provided by the VoIM networks connected the VoIP gateway 152 and communication mediation subsystem 150. The IM/VoIM networks sharing presence information may be MSN Messenger™, Yahoo! Messenger™ with Voice, Google Talk™, AOL Messenger™, Gizmo Project™ or enterprise IM networks/services or other presence services.

The IM presence servers manage and transmitted presence information between IM users. Presence information may be implemented using open standards protocols for such as XMPP (eXtensible Messaging Presence Protocol), SIMPLE (Session Initiation Protocol for Instant Messaging and Presence Leveraging Extensions) and SIP (Session Initiation Protocol), or proprietary IM protocols such as that of Microsoft's MSN™ network. The dynamic contact engine 510 may collect presence information 508 from any open source or proprietary instant messaging network. Suitable methods of interconnecting to open source and proprietary instant messaging networks are known in the art, for example, for accessing presence information of respective IM networks. The present disclosure is not directed to any particular method of interconnecting between open source and proprietary instant messaging networks and so will not be described in detail herein. Examples are described at http://en.wikipedia.org/wiki/Instant_messaging as at Nov. 30, 2007. Moreover, the method of interconnecting between instant messaging networks does not affect the use of presence information sent or received, and does not affect the way in which presence information is used in the present disclosure.

In at least some embodiments, the communication mediation subsystem 150 may provide instant text messaging/chat capabilities. In such embodiments, the communication mediation subsystem 150 relays instant messaging text communications between IM users of the same or different IM networks.

As described above in connection with FIGS. 3 and 4, instant messaging text and presence information may be provided to the user, however the IM text communications and presence information do not originate with the communication mediation subsystem 150. IM text communications and presence information are provided to the communication mediation subsystem 150 by respective IM networks and re-transmitted to the computing device 301 for display within the GUI. The communication mediation subsystem 150 relays instant messaging text and presence information in accordance with defined rules and preferences.

The dynamic contact engine 510 collects the presence information 508 and uses it in evaluating the predefined rules for generating the dynamic contact list. For contacts in the dynamic contact list having presence information 508, it is transmitted to the computing device 301 and presented together with the contact information of the electronic contact records in the GUI on the display screen of the computing device 301. This allows the user to view the presence information 508 of their IM contacts/buddies or other contacts having presence information 508 in the dynamic contact list.

Typically, contacts and IM networks are invited to share presence information and must accept the invitation and agree to share presence before the dynamic contact engine 510 may access presence information concerning those contacts and IM networks, and before the user can view the presence information of their contacts in the GUI. Some contacts may choose to share presence with the user and/or system 600 while others may not. Similarly, the user may choose to share presence with some contacts and/or system 600 but not others.

Rules governing the access and use of presence information 508 are applied by the dynamic contact engine 510 to filter the presence information which is used when generating the dynamic contact list and when transmitting the dynamic contact information to the computing device 301. The rules are typically defined to ensure that the use of presence information complies with the policies and terms of use of the various IM/VoIM networks, and that only presence information of IM contacts who have agreed to share presence information with the user and/or system 600 are used, among other things.

In at least some embodiments, a transcoder (not shown) transcodes presence information from an open source or proprietary instant messaging network protocol of one IM network to that of another IM network. Transcoding presence information between the various encodation protocols allows presence information to be shared and transmitted between IM users of the same or different IM networks regardless of the originating open source or proprietary instant messaging network encodation protocol. The present disclosure is not directed to any particular method of transcoding presence information between open source and proprietary instant messaging network encodation protocols and so will not be described in detail herein.

The presence information 508 may be any presence state published by a user to indicate a current communication status. This published state informs others that wish to contact the user of his or her availability and willingness to communicate. The presence information 508 may relate to the user's availability to take a voice call, in particular the user's availability to take a voice call on a particular telephone number (e.g., at a respective landline telephone, mobile telephone or VoIP phone), at an IM address/identity (for a VoIM client 130), or an SIP URI (for a VoIP phone or softphone 128). Current standards support a rich choice of additional presence attributes that can be used for presence information, such as user mood, location, or free text status. While presence information 508 may relate to the user's “online” status on an IM network, but is limited to “online” status.

The presence information 508 change based upon a number of factors including:
(a) an actual state of the user, entity or group represented by the contact which is determined by the state of the IM client, their respective computing device 301 (i.e., computer or mobile telephone) or other device providing presence information (such as a telephone). This may include, but is not limited to, whether the contact is online (i.e., signed into an IM network), whether the computing device 301 is turned on or off, whether the user is physically at the computing device 301, whether the user is occupying the resource (i.e., user is on the phone), whether another user or users are occupying this resource (i.e., telephone line is busy) and making it unable to meet the needs of any other users until they have freed it;
(b) manual updates affected by the user or user's enterprise where a specific presence status is selected to be shown for the user, entity or group; and
(c) automated updates affected by the user or user's enterprise based on rules such as time of day.

Updated presence information 508 (and possibly contact information) may be received via synchronization with user's computing device 301 via pushed updates from calendar entries of a personal or enterprise calendaring system (which may be implemented by the messaging server 312 as part of a PIM (personal information manager) application such as Microsoft Outlook™ using Microsoft Exchange™). Pushed updates may also be received by third parties such as a colleague, friend, travel agent, for example as a calendar entry to be added to the calendaring system. These updates may used to provide or update presence information 508 about the user, for example providing status, availability etc. A calendar change reflects a change in the presence information 508 that the user and other users of the system 600 will see (assuming you have agree to share presence). Calendar information such as information about calendar entries may also be used when generating the dynamic contact list. For example, if there is a upcoming meeting, then the relevant contacts (such as internal resources) would be include in the dynamic contact list. Similarly, other users (contacts) of the system 600 who are at the meeting (i.e., who accepted or been invited to the meeting in the respective calendar entries) would have the instant user in their dynamic contact list and would see the presence (status) of the instant user assuming calendar information is shared and an appropriate rule 504 has been defined for the dynamic contact engine.

In at least some embodiments, enterprises may change the presence status/value for any contact within their group manually or automatically using rules such as opening hours, priority of relationship between the enterprise and different contacts such as customers. The process by which such updates are implemented is unrelated to the present disclosure and so will not be described in detail herein. Assuming the updated presence information is effected in the presence information 508, or is placed into the appropriate field within the dynamic contact information stored by the dynamic contact engine 308, it will be applied by the dynamic contact engine 308.

While presence information 508 has been primarily described in the context of IM presence information from IM networks, other sources of presence information may be provided and association with contact information any one of the contact sources described above. Other sources of presence information may be an enterprise presence service provided via proprietary services or third party services used by the enterprise. A presence service is a network service which receives stores and sends presence information to users or enterprise subscribing to the presence service. The presence service may be implemented as a single server or have an internal structure involving multiple servers and proxies.

In at least some embodiments, the presence information 508 may be used by the communication mediation subsystem 150 to determine which destination identifier of the dynamic contact in the contact list should be used when connecting a voice call. In such embodiments, presence information 508 is associated with the available destination identifiers for the one or more parties to be called. For example, the presence information 508 may indicate that a user is “At Work” and so the office telephone at the contact's place of business should be used to connect the voice call. Thus, presence information 508 may be used to determine which destination identifier of a contact should be dialed without user input. It will be appreciated that presence information 508 is not created by the communication mediation subsystem 150, but is used as the basis for rules in voice call routing connection so as to make a routing decision in respect of the called party, i.e. to choose the appropriate communication channel and associated destination identifier.

### Location Information

The dynamic contact engine 510 may also collect location information 506 relating to users of the communication mediation subsystem 150 and contacts in the contact sources described above. Location information concerning the user's current geographic location may be determined in different ways. Location information may be provided by the user location information provided by the user (for example, if the user's device does not have location services or if the user does not wish to use such services, for example, because of privacy concerns) and stored by the dynamic contact engine 510, for example via the GUI on the computing device 301. The user may specify the current location, for example in a temporary location field, or specify that they are in a home or fixed location, or at one of a number of predetermined locations.

Alternatively, the location of the user may be determined by a location server providing location services. If the user or the user's wireless carrier/service provider will have enabled location based services these services may be used to enable the real-time update of the user's location to determine. The location may also be determined by a Global Positioning System (GPS) using information provided by a GPS transmitter such as in a mobile telephone or GPS device of the user, an assisted GPS, or a location server of a wireless communication network which determines location by triangulation based on location information provided by a plurality of transceiver base stations of the wireless communication network. Assisted GPS is a service provided by many wireless telecommunications carriers in which a combination of GPS information obtained from satellites is combined with triangulation information from transceiver base stations of the wireless network 104 to determine the location of the mobile communications device 102.

Location information 506 concerning contacts may be determined from the location information in the contact information, for example, in the address field of a contact record. Location information 506 concerning contacts may also be provided by the contact and stored by the dynamic contact engine 510, or may be provided using one of the alternative sources of location information described above.

### Use of Dynamic Contact Information

After collecting contact information, presence information and location information, the dynamic contact engine 510 consolidates this information to generate “rich” contact information referred to as dynamic contact information. The dynamic contact information may comprise contact information comprising one or more of the following:
(1) a name (full or partial) and/or possibly a business name;
(2) one or more street and/or postal addresses;
(3) one or more telephone numbers (such as mobile or landline telephone numbers);
(4) one or more email addresses;
(5) one or more instant messaging (IM) identifiers (IDs) or address from public and/or private instant messaging networks;
(6) an SIP URI (session initiation protocol uniform resource indicator) address used in VoIP Internet telephony;
(7) a description (for example, text, notes, personal information, an Internet hyperlink or other non-categorized information, etc.),
(8) a permanent or “home” location;
(9) a temporary location (for example, where the contact changes location from time to time);
(10) a URL (Uniform Resource Locator), Internet hyperlink or other link to extended information;
(11) a type (e.g. friend, colleague, customer, external resource, or other relationship to contact); and
(12) presence information which specifies the disposition or availability of a contact.

The dynamic contact information is stored in memory by the dynamic contact engine 510. As contact information may appear in more than one contain sources, consolidates contact information, presence information and location information into dynamic contact information may comprise removing duplicative information or records for contacts. The dynamic contact information may change and is updated at regular intervals. For example, dynamic contact information, in particular presence information, may be updated constantly or almost constantly to provide real-time or near real-time dynamic contact information. The dynamic contact information may have more than one identifier of each type. Other information such as a company name may also be provided in the dynamic contact information.

The type field (11) may be based on a predefined classification system created by an enterprise administrator for example. In some embodiments, the value of the type field is one of number of predefined type classifications. The type of each contact may be populated based other information about the contact from the contact source, or may be defined by the enterprise administrator. The type field could specify the type of business or that the contact is an external resource or internal resource.

The dynamic contact information may comprise a URL, hyperlink, or other link and/or instructions to access extended information. The extended information may be a link to the web page of the contact. Accessing the extended information typically requires the user to request the extended information, for example by invoking a link the resource which will then automatically invoke the associated application on the computing device 301 and process the link to extended information, for example by requesting and downloading (receiving) the extended information. For example, where the link (10) is a hyperlink, input selecting the link will launch the Internet browser 404 on the computing device 301 and instructs it to request, download and display the hyperlink resources on the display screen of the computing device.

Extended information may be mapping or directional information to the contact. For example, the dynamic contact information may be used to generate an electronic contact record comprising a link or hyperlink to invoke a mapping application on the computing device 301. The link may invoke or cause the mapping application to display on the display screen of the computing device 301 a map of the location of the contact when the linked is selected or launched by the user via respective input. The link may be a hyperlink for execution by an Internet browser on the computing device to invoke a page comprising a map of the location. In addition to or instead of a map, directions from the location of the user to the location of the contact specified in the electronic contact record may be displayed on the screen of the computing device 301. Thus, a user view the dynamic contact list may view the address of a contact in the dance contact list which has been determined to be in close proximity to the user (i.e., within a predetermined proximity of the user's current location, for example determined via location based services), then view the address of the contact, and then invoke a map and/or directions for the address.

The extended information may also comprise profile information about the contact. Where the contact is a business contact, the extended information may be a link to a web page or to customer or critic reviews about the business (i.e., good service, bad service, etc.) If the contact is an RSS feed 524, the extended information may be information about current or upcoming events, for example a band or a DJ appearing a club that day. The extended information may be filtered based on the rules, for example, to display only information for the day, evening, or the weekend, etc.

After the dynamic contact information has been collected, it may be presented in a number of ways depending on the permanence of the dynamic contact information and depending on whether it should be displayed to the user or only available for search.

The dynamic contact information may be located in three separate stores but may exist in more than one or in all three stores. The locations of the three stores are: an Instant Messaging presence or buddy list; (2) a contact list or address book; and (3) a search store. The IM list is a list of IM contacts and associated presence. The contact list is a list of contact records that be searched or looked up alphabetically. The search store is a database of searchable contact information which can be searched in the same way that Internet searches can be performed. This information is returned in response to requests based on one or more keywords.

A dynamic contact list is generated from the dynamic contact information (i.e. from the contact information, presence information and location information) based on the one or more rules for including contacts in the dynamic contact list. The dynamic contact list comprises electronic contact records of contacts having contact information, presence information and/or location information which match the one or more rules. The dynamic contact list is transmitted to the computing device 301 for display on the display screen of the computing device 301. The dynamic contact list may be displayed within a unified or combined list of contacts. For example, personal contacts, enterprise group contacts, IM contacts and RSS feeds may each appear as separate contacts but within a single list of contacts (i.e., the dynamic contact list) displayed on the computing device 301. The method through which the dynamic contact list is displayed is referred to as the presentation layer. The presentation layer does not affect the function of the described processes and will not be described herein.

The dynamic contact list displays the electronic contact records of contacts in any order the user chooses. In at least some embodiments, the electronic contact records may be logically grouped into classifications in accordance with information about the electronic contact records. The dynamic contact list may be displayed on the computing device 301 with the electronic contact records presented within the respective logical groupings. The logical groupings may comprise one or more of personal contacts, internal resources and external resources. Internal resources are typically users, user groups other contacts of the enterprise selected from the enterprise contact list 512. External resources are typically users, user groups other contacts of the third parties such as external businesses from the third party contact list 520.

The internal resources may be logically grouped into subgroups referred to as resource groups such as administrative, professional, executive, sales, marketing, transportation, restaurants, entertainment, valet, business centres, etc. Further subgroups may be defined, for example, the administrative resource group may have resource subgroups comprising technical support, secretarial service and product support.

The external resources may be external business with whom an enterprise has a preferred commercial relationship. Preferred external resources may be travel agencies, printing services, car rentals, limousine, restaurants, temporary office space, and shopping locations. The enterprise may or may not have a commercial referral relationship with these contacts. Preferences may be based on the price of goods or services or other factor. Preference may be stored in the dynamic contact information, for example under the description (7) field or type field (11) using an appropriate identifier or tag (i.e., “low cost external” or “preferred”), or as metadata maintained by the dynamic presence information along with the preferences 507 or third party contact list 516. Information concerning preferred external resources (e.g., third party business) may be stored in preferences 507 which are accessible by the dynamic contact engine 510 when generating the dynamic contact list. This information may appear in the dynamic contact information in the type (10) field as preferred, or preferred external, etc. In this way, the dynamic contact engine may use the type (10) field to determine which contacts to include in the dynamic contact list or a priority within the dynamic contact list. For example, only preferred external resources may be included, or preferred external resources may be displayed at the top of the list in a descending order. A hierarchy, ranking or classification system may also be implemented to establish levels of priority, for example, most preferred, preferred, and not preferred. Any suitable ranking system may be used. A “tiered” preference system may also be used for internal resources.

The above examples are meant to be illustrative and not to be limiting. Any system of logical grouping and sub-grouping may be defined by the enterprise administrator based on any chosen descriptions/classifications by the enterprise administrator, a contact description provided by the respective contacts in relation to the predefined groups/classifications, or the administrator's description of the respective contacts in relation to the predefined groups/classifications.

The logical groupings may be determined in accordance with a predefined type in the dynamic contact information. The type may be determined from the source contact information, or may be defined by the administrator. Examples of define types are friend, colleague, customer, internal resource, or external resource). Within each logical grouping, the order of the contact records is typically alphabetical (sorted by name). Alternatively, the order within each logically grouping may be based on a predetermined priority. The user may be given the option to choose between alphabetical or priority based ordering within the logical groups. The priority may be the most frequently used (i.e., dialed, emailed and/or text messaged, etc.), the most relevant based on the time and day (for example, in evening dinner restaurants at the top, lunch restaurants below, breakfast at the bottom), and availability (available towards the top of the list, with unavailable or “away” below). Two or more basis for priority may be combined to determine the ordering within the logical grouping. Typically, the most relevant or the contacts having the highest priority are placed at the top in descending order of relevance/priority to limit the scrolling or navigation in the dynamic contact list.

With respect to external resources, the priorities may be availability, relative location to the user, and price of goods or services. For example, restaurants may be sorted by location with the closest to the user at the top, or may be sorted by price with cheapest at the top. Two or more basis for priority may be combined to determine the ordering within the logical grouping.

### Rules for Generating the Dynamic Contact List

The dynamic contact engine 510 selects contacts for inclusion in the dynamic contact list based on contact information, presence information and/or location information in accordance with one or more rules 504 for including a contact in the dynamic contact list and business and/or user preferences. The rules 504 may be defined by the administrator (i.e., enterprise or business) or the user. One or a combination of rules 504 defined by one or both of the administrator and user may be used in selected contact records to be included in the dynamic contact list, and the contact information which is to be included in dynamic contact list. The business rules and personal rules are applied by the dynamic contact engine 510 based on predefined business and personal preferences 507, respectively. The predefined preferences 507 may be defined for individual users, groups of users (each associated with a list of one or more users), or may be globally defined for all users (i.e., all users and user groups).

The rules 504 may comprise business rules which define contact sources, individual contacts within an enterprise contact list 512, groups of contacts (i.e. user groups) within an enterprise contact list 512, and criteria for selecting contact sources, individual contacts within an enterprise contact list 512, or groups of contacts within an enterprise contact list 512 from which electronic contact records may be populated to the dynamic contact list, and combinations thereof. The business rules allow administrator to control which users in the enterprise contact list 512, for example employees or other individuals, will have their contact information shared with the dynamic contact engine 510 and with whom. Thus, the business rules may be used to define who will share contact information and who it will be shared with. The business rules may be for individual users, groups of users, or may be globally defined for all users.

To illustrate, a business rule may be based on user groups in the enterprise contact list 512 and defined so that users share or do share contact information with users based on their associated user groups. Business rules based on user groups may be defined to allow users within the same user group to share contact information with each other to exclusion of other user groups, or to share contact information with one, some or all of the other user groups. Typically, the enterprise administrator determines which user groups will share contact information with each other. The sharing of contact information may be one or two-way. For example, users of user group B may share contact information with users of user group A, but users of user group A may not share contact information with users of user group B.

For example, a salesman in corporation ABC Inc. may not be able to view the location information or presence information of the CEO of corporation ABC Inc. Plain contact information may be available to the salesman via the enterprise contact list 512. However, the CEO and VP of sales in corporation ABC Inc. may be able to both the contact information and presence information of the entire sales team. This allows the CEO and VP to access allowing the contact information, location information and presence information of the sales team to be determined at any time.

The business rules may also define what type of information will be shared and with whom. For example, the business rules may allow users to see all dynamic contact information, including plain contact information, location information, and presence information, or just plain contact information. The business rules may also comprises other criteria for sharing contact information with users in the enterprise contact list 512. The business rules may be based on any criteria the enterprise administrator chooses.

The business rules may also define which internal resources are “available” on certain dates and times and to which individual or groups of employees. The business rules may define which external or third party resources are “available” on certain dates and times and to which individual or groups of employees. Alternatively, this information may be provided in the form of “availability” presence information.

The rules 504 may comprise personal rules which define sources, individual contacts within the personal contact list 502 and/or enterprise contact list 512, groups of contacts (i.e. user groups) within the personal contact list 502 and/or enterprise contact list 512, and criteria for selecting contact sources, individual contacts within the personal contact list 502 and/or enterprise contact list 512, or groups of contacts within the personal contact list 502 and/or enterprise contact list 512 from which electronic contact records may be populated to the dynamic contact list, and combinations thereof. The personal rules are similar to business rules, differing primarily in that they are defined by the user. The personal rules may allow users to specify that no external contacts or resources (i.e., third party contact information) should be included in the dynamic contact list, among other things. The personal rules may be defined by the user through the GUI.

Personal rules take into account user preferences when generating the dynamic contact list by allowed the user to select the contacts or type of contacts which may be added to the dynamic contact list, or which may be used to selected contacts for inclusion in the dynamic contact list in accordance with other rules. Contact type or class may be determined based on predetermined types or classes of the respective contacts (e.g., the type field (11) in the above example) which may vary between different embodiments and configurations of the communication mediation subsystem 150.

The rules for inclusion in the dynamic contact list may also be based on one or a combination of the following factors:

(1) geographic location of the user relative to the contact. To be include in the dynamic contact list, the user must be within a predetermined proximity of the contact. The location of the contact is typically determined via the location provided by the contact information. A location of the user and the contact must be known to create the necessary geographic cross reference the user and the contact;

(2) presence information of the contact. If the presence information of the contact is negative, i.e. in the case of an individual contact that the contact is unavailable, or in the case of a business contact that the business is closed;

(3) relationship between the user and contact. This may be based on a contact type of other information in the dynamic contact information. Contact information and/or presence may be presented differently based on the relationship so that, for example, a contact record may appear if a sufficient relationship exists between the user and the contact, but will not appear if the relationship between the user and the contact is not sufficient. The type of information which is presented in the dynamic contact list may also be affected by the relationship. For example, plain contact information but not presence information may be displayed if the relationship between the user and the contact is not sufficient to display presence;

(4) resource availability (type of presence information)—a contact may have an availability that changes based on being occupied with one or more other users (for example, customer service representative) or capacity (for example, a restaurant is full or fully booked for a period of time);

(5) time availability (type of presence information)—an individual contact, user group or business contact may be available, unavailable or have reduced capacity at certain times (e.g., the business opening hours or known capacity based on time of day and/or day of week, etc.). Contacts may included in the group;

(6) resource cross-dependency (type of presence information)—a contact may have changing presence or availability based upon a cross-reference to another contact (e.g., an outside restaurant may be shown based on an internal restaurant in a hotel being closed or fully booked);

(7) date and time—a user may only wish to have contact information added to their personal contact list 502 and/or enterprise contact list 512 during certain time periods (for example, only during business hours and not during evenings and/or weekends); and

(8) date and time/geographic location combination—a user may specify that they are going to be in a certain location during a specific time period (for example, an itinerary may be provided, the itinerary comprising a plurality of entities each comprise a dates and/or times and location). The contact information for the duration of the itinerary may be added to their personal contact list 502 and/or enterprise contact list 512 in advance of the trip (for example, arriving at New York JFK airport on November 6^{th} will add contacts for hotels and limousines in the New York JFK area at predetermined time prior to arrival). The itinerary may also specify times during the duration of the itinerary that are to be considered work and private. The work/private distinction may be used as presence information to indicate that the user is not available. The foregoing also applies to contacts when dynamic contact lists are generated in which the user is a contact. This may be determined based on calendar entries.

### Example Use Case

An example use case scenario will now be described for the purpose of illustration. A user is travelling and not within the proximity of a home location or other fixed location such as their office. For example, an enterprise user of ABC Inc. having both a Toronto and Ottawa office travels from the home location of the Toronto office to the Ottawa office of ABC Inc. Now that the user is in Ottawa, the user may want to access contact information for local internal contacts such as employees of the Ottawa office, and external contacts such as business centres/printing services (e.g., Kinkos™), restaurants, and entertainment, etc. For example, a user may wish to know the contact information for local printing services.

The corporate contact list in Ottawa may provide contact records or information for local printing services; however this information alone may not be sufficient for a user to choose a suitable contact. For example, the user may not be familiar with his or her current location (i.e., Ottawa) and may not be able to discern from the contact records which printing services contact is the closest to the user. Furthermore, the user will likely not know its operating hours. Therefore, in seeking to contact local printing services the user may inadvertently select contact records for printing houses which may be far away from the user's location in Ottawa and/or which may not be open for business. This is both time consuming and frustrating to the user. However, if location information (i.e., the user's location and distance to the respective contact) and presence information (i.e., the time availability of the contacts) are used, a dynamic contact list may be generated and presented to the user which comprises contact records for local printing services which are closest to the user and which are currently open. Furthermore, the contact records within the dynamic contact list may be ordered based on relevance/priority.

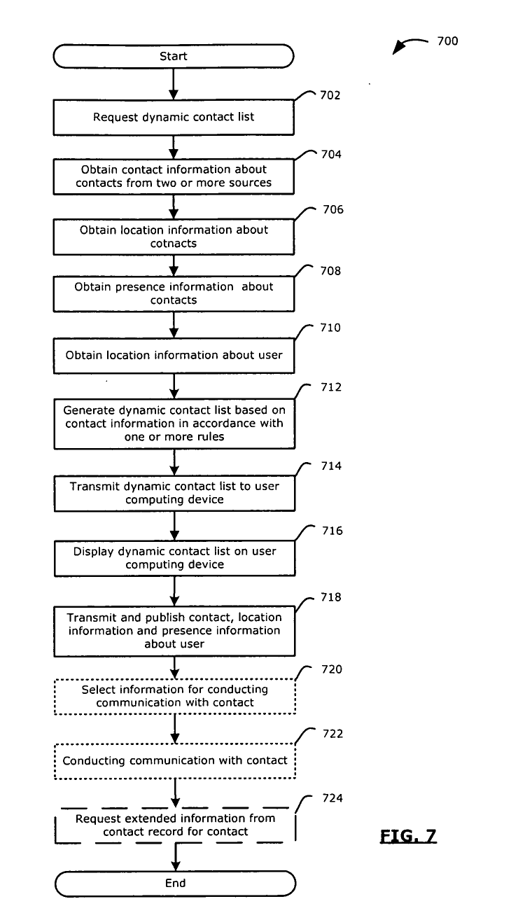

Referring now to FIG. 7, example operations 700 for generating a dynamic contact list in accordance with one embodiment of the present disclosure will now be described. The operations 700 assume that the user or user's organization (e.g., company) has created a service account on the system 600 or network running the dynamic contact engine 510, and that the user has a contact list or electronic address book stored in a location accessible by the dynamic contact engine 510.

In a first step 702, a user of the computing device 301 uses a GUI to access the system 600 and requests a dynamic contact list be generated. The computing device 301 may be a personal computer 101 or a handheld mobile communication device 102 having at least data capabilities such as a smartphone, or other suitable device such as a navigation device such as a GPS device through an application installed on any of these devices where the application provides a visual user interface in place of the Internet browser 404 The request may be direct or indirect. For example, requesting access to the electronic address book on the computing device 301 or a dynamic contact list may automatically invoke the operations 700. The user logs into the application or web portal using their username or other identifier (ID) and a password or personal identification number (PIN) through the application or browser on the computing device 301.

The dynamic contact engine 510 access user account details such as personal and/or business preferences 507 and personal and/or business rules 504 for generating a dynamic contact list. Successfully logging into the system 600 authorizes the user for a session. A session may have a user configurable expiry time set and uses a security ticket to prevent unauthorized access to the information by intercept during the life of the session. A security ticket is a time limited access code provided by the network server 154 to allow the user to communicate with the server 154, for example to send requests and receive responses. If a user does not have a valid security ticket, the server 154 will ignore any requests for information (presence, contact information etc.).

In the next step 704, the contact information from two or more of a number of contact sources is collected by the dynamic contact engine 510. As described above, the contact sources typically comprise a personal contact list 502, an enterprise contact list 512, a third party contact list 516, and an IM contact list 516. Other sources such as RSS feeds or documents 520 or other sources may also be available.

In the next step 706, the presence information 508 about contacts is collected by the dynamic contact engine 510. Presence information 508 may be from an IM presence server or other presence services as described above. If presence information 508 is not available or is not being shared, this step is omitted. Presence information 508 may also be collected for the user for use in the operations 700 (i.e., in evaluating the rules), or later for publication to the system 600.

In the next step 708, the location information 506 about contacts is collected by the dynamic contact engine 510. Location information 506 may be from the contact information or from location services or other source of location information as described above. In some embodiments, if location information 506 is determined solely from location services but such services are not available, this step is omitted.

In the next step 710, the location information 506 about the user is determined. The user's location may be provided by the user (for example, if the user's device does not have location services or if the user does not wish to use such services, for example, because of privacy concerns). For example, the user may specify a current location, for example in a temporary location field, or specify that they are in a home or fixed location, or at one of a number of predetermined locations. Alternatively, the location of the user may be determined by a location server or other location services as described above.

In the next step 712, a dynamic contact list comprising one or more electronic contact records with contact information from the contact sources is generated in accordance with one or more rules for inclusion in the dynamic contact list. The rules for inclusion in the dynamic contact list may be based one or a combination of contact information, metadata about the contact information (for example, a relationship between the user and the contact, or a classification or type of the contact), presence information and location information. Generating the dynamic contact list may comprise determining contacts in the contact sources which match the rules for inclusion in the dynamic contact list, and populating the dynamic contact list with electronic contact records for contacts which match the rules. The dynamic contact list is populating with electronic contact records comprising one or more elements of the dynamic contact information. The dynamic contact information may comprise each of the fields (1) to (12) (fields being empty or omitted if no data is available), or may be a subset of the available data in accordance with rules 504 and/or preferences 507. For example, presence information may not be provided depending on the rules 504 and the preferences 507 regarding whether to share presence.

The electronic contact records in the dynamic contact list typically comprise at least a destination identifier comprising one or more of: a telephone number (e.g., such as a home and/or business telephone number), a mobile telephone number, an instant messaging (IM) address, and a session initiation protocol uniform resource indicator (SIP URI).

In at least some embodiments, generating the dynamic contact list comprises: determining contacts in the contact sources which match the rules, populating the dynamic contact list for contacts from one or both of a personal contact list 502 and an enterprise contact list 512 (i.e., internal resources), and then further populating the dynamic contact list with electronic contact records for contacts in the contact sources which match the rules. In this way, the dynamic contact engine 510 adds contacts from contacts sources such as a third party contact list 516 (i.e., external resources), an IM list 520, RSS feeds 524, and other contact sources.

In other embodiments, generating the dynamic contact list comprises: determining contacts in the contact sources which match the rules, populating the dynamic contact list with contacts from an IM list 520 (optionally also a personal contact list 502 and/or an enterprise contact list 512), and then further populating the dynamic contact list with electronic contact records for contacts in the contact sources which match the rules. In this way, the dynamic contact engine 510 adds contacts from one or more contacts sources such as a personal contact list 502, an enterprise contact list 512, a third party contact list 516 (i.e., external resources), RSS feeds 524, and other contact sources 528.

Next, in step 714 the dynamic contact list is transmitted from the dynamic contact engine 510 to the computing device 301.

Next, in step 716 the dynamic contact list is displayed on the display screen of the computing device 301. The electronic contact records of the dynamic contact list may be logically grouped into classifications in accordance with information about the electronic contact records. In such embodiments, the dynamic contact list is displayed on the display screen of the computing device 301 with the electronic contact records presented within respective logical groupings. The logical groupings may comprise personal contacts, internal resources and external resources.

Presence information associated with at least some of the electronic contact records in the dynamic contact list may be presented together with the contact information of the electronic contact records on the display screen. Whether presence information is displayed depends on whether presence information is available, whether the contact has agreed to share presence information and/or whether the user and contact relationship or other information matches one or more rules for displaying the contact's presence information in the dynamic contact list displayed on the display screen of the computing device 301.

Next, in step 718 one or more of contact information, location information and presence information is transmitted to the dynamic contact engine 510 where it is stored. The location information and presence information may be published by the dynamic contact engine 510 to users of the communication system 100, for example, on presence servers and location servers used by the dynamic contact engine 510 or on a local store. This allows other users to access the contact information, location information and presence information of the user during the generating of dynamic contact lists, assuming that the user has agreed to share this information.

Next, in step 720 the user may optionally select a specific contact from the dynamic contact list or may be selected by a contact search by name or keyword, and to initiate communications with the contact. The instructions to initiate communications with a contact in the dynamic contact list may comprise one or both of a destination identifier for the communication and a communication type. The destination identifier may be a telephone number, an email address, an instant messaging (IM) address, and a session initiation protocol uniform resource indicator (SIP URI). Based on the contact information of selected contact in the dynamic contact list and the contact element (and associated destination identifier) of the contact record selected by the user, the user may connect to the selected contact through one of the following methods: (1) a voice call to a telephone number, IM address or SIP URI, (2) an email message to an email address, (3) an IM message to an IM address, (4) an Short Message Service (SMS) message to a telephone number, and (5) an Multimedia Messaging Service (MMS) message to a telephone number. A connection type may be provided if the selected destination identifier supports multiple functions, such as a mobile telephone with voice and data capabilities (i.e., email, SMS/MMS, etc.).

Voice calls may be between any receiving and originating telephones (such as a landline/PSTN telephone, mobile telephone, or VoIP telephone) or voice clients on a computing device (such as a VoIP softphone or VoIM client) running on a computer or smartphone, and using either a direct call, call back, or call-in functionality. An email message may include a voice message attached in the form of an audio file. If the technical capabilities exist, an MMS may include a voice message in the form of an audio file.

Next, in step 722 the communications are conducted in accordance with the selected destination identifier and communication type.

Next, in step 724 the user may optionally request extended information, for example by invoking a URL or link an electronic contact record of a contact using the input devices of the computing device 301. This may invoking the Internet browser 404 to display a web page or other data pointed to in the link field (11) of the dynamic contact information, or a mapping application (possibly within the Internet browser 404) to display a map or directions to the contact.

While the operations 700 have been described as being performed by the dynamic contact engine 510, it will be appreciated that in other embodiments at least some of the steps may be performed by the computing device 301 provided that it has access to the contact information, presence information, location information and other information necessary to perform the operations 700.

While the operations 700 have been described as occurring in a particular order, it will be appreciated to persons skilled in the art that some of the steps may be performed in a different order provided that the result of the changed order of any given step will not prevent or impair the occurrence of subsequent steps. Some of the steps described above may be combined in other embodiments, and some of the steps described above may be separated into a number of sub-steps in other embodiments.

The manner in which voice, email, SMS, MMS, and instant messaging communications to a contact in the dynamic contact list are initiated and connected is outside the scope of the present disclosure and will not be described in detail herein. A suitable method of initiating a voice call via a destination identifier comprising one of a landline telephone number, a mobile telephone number, an instant messaging (IM) address, and a session initiation protocol uniform resource indicator (SIP URI), is described in co-pending U.S. patent application Ser. No. 11/697,066 and PCT patent application no. PCT/CA2007/000592 entitled “A METHOD AND SYSTEM FOR SMART ROUTE DIALLING TO A DESTINATION IDENTIFIER USING A TELEPHONE”, published as U.S. 2007/0238472 A1 and WO 2007/112594 A1 respectively on Oct. 11, 2007. The entire contents of both documents being incorporated by reference herein.

Voice calls between a calling party and one or more called parties may be connected between callers (i.e., calling and called parties) using the same or different voice communication protocols. The calling and one or more called parties may use a landline telephone, a mobile telephone, a Voice over Instant Messaging (VoIM) client, or Voice over Internet Protocol (VoIP) phone or client. The voice call may be connected without requiring the calling party to choose the destination identifier/contact information to be used for connecting to the one or more called parties, and without the calling party having to known or selected the communication protocol(s) and connections(s) to be used for connecting the voice call. In some embodiments, this may be achieved from a common interface which requires the user to merely select the parties to be called. The processing and connections required to establish the voice call being performed and established by the interface in a manner which is invisible to the user.

For a calling party to connect to the communication system 100, a user requires a computing device for accessing a graphical user interface (GUI) for transmitting connection instructions to the communication system 100 (e.g., to the network server 154 and/or VoIP gateway 152) typically via an Internet connection, and a voice-enabled communication device such as a telephone or voice client for connecting the voice call. The computing device and communication device may be the same or different devices. The GUI may be provided by a mobile communication device 102 having both voice and data capabilities (sometimes referred to as a smart phone) or a computer. The telephone may be a landline telephone (such as a public switched telephone network (PSTN) phone or VoIP phone) or mobile telephone. The voice client may be a VoIP softphone or VoIM client on a computer.

In at least some embodiments, the GUI allows users to view a contact list comprising electronic contact records each comprising contact information details which comprise at least a contact name and a destination identifier comprising one or more of: a landline telephone number, a mobile telephone number, an instant messaging (IM) address, and a session initiation protocol uniform resource indicator (SIP URI). Other information such as business name, address and other contact information may also be in the contact records. The contact list may be stored locally on the computer 101 or mobile communication device 102, stored remotely on a network server, or may be a consolidated contact list dynamically generated from the local contact list and the contact list on the network server. Rules may be applied to select contact records from the local and network contact lists when dynamically generating the dynamic contact list.

A calling party may select a destination identifier and instruct the communication system 100 to connect a voice call without the user having to know how to connect the voice call for the selected destination identifier. In some embodiments, a calling party may select a contact record and instruct the communication system 100 to connect a voice call without the user having to know which destination identifier should be used. In such embodiments, the communication system 100 may select the appropriate destination identifiers based on presence information associated with the destination identifiers in a contact record of the contact list.

A voice call may be connected to a called party using one of several different methods. In accordance with the first method, a smart phone or mobile communication device 102 having both voice and data capabilities, or a computer having a VoIP softphone or VoIM client for establishing the voice call is used. Using this method, the communication device on which the GUI is accessed is used to connect the voice call. It should be appreciated that even though the mobile communication device and computer could be used to connect the voice call, the user may still choose to use one of the alternative methods described below. The mobile communication device or voice client is used to call a VoIP gateway at a local access gateway number. The local access gateway number is typically a local or toll free telephone number having no associated charge. This may bypass costs associated with dialing national, mobile and/or international calls directly at the rates that would be normally charged. This is commonly referred to as a “toll bypass”.

The VoIP gateway then routes the voice call to the called party at the destination identifier. Depending on the type of connection associated with the destination identifier, i.e. a landline telephone, a mobile telephone, a Voice over Instant Messaging (VoIM) client, or Voice over Internet Protocol (VoIP) phone or client, the voice call is routed over the respective, PSTN, wireless network, VoIP network, or VoIM network. If the destination identifier corresponds to a landline or mobile telephone, least cost routing is used to determine and route the voice call in a cost effective manner. This occurs without the user having to know the possible connection options for connecting the call or the associated costs. If the destination identifier corresponds to a landline or mobile telephone, the destination phone number may be converted into the E.164 international dialing format based on the home location of the mobile communication device and the current location of the mobile communication device. If SIP URIs or IM identifiers/addresses are called, the VoIP gateway routes the calls from the originating voice communication device to the respective VoIP or VoIM end points, allowing the connection of a voice call originating on a conventional telephony network (i.e., such as a cellular network) with an SIP-enabled VoIP phone or client or VoIM client. Conventionally, voice calls cannot be connected between these types of networks. The protocol and signalling conversion provided by the VoIP gateway allows such connections to be made.

In accordance with the second method, a call back number and telephone is used. A call back number may be used, for example, because the user has no mobile telephone or the user's mobile telephone lacks the functionality to provide the GUI (i.e., it has no data functionality, lacks a browser, or lacks Java™ support—in this case the GUI is accessed by a computer) or because using the call back number may result in a lower cost than if the voice call originated from the mobile phone. A call back number may also be used because, if the GUI is accessed by a computer, the computer lacks the functionality to provide a VoIP softphone or VoIM client. The VoIP gateway calls the user's call back telephone at a designated call back number. This may be any telephone number provided by the user. This may be a stored setting or option, or may be provided by the user prior to the call being made. If the user accessed the GUI via their mobile telephone, they may choose their mobile telephone number as the call back number, for example, because it may result in a lower cost. Once the call is answered on the call back telephone, the call back telephone is connected to the VoIP gateway. The VoIP gateway then routes the voice call to the called party at the destination identifier, as described above.

In accordance with the third method, a call-in number and telephone is used. A call-in telephone number may be used, for example, because the user has no mobile telephone or the user's mobile telephone lacks the functionality to provide the GUI (i.e., it has no data functionality, lacks a browser, or lacks Java™ support—in this case the GUI is accessed by a computer), or because using the call-in telephone may result in a lower cost than if the voice call originated from the mobile phone. A call-in number may also be used because, if the GUI is accessed by a computer, the computer lacks the functionality to provide a VoIP softphone or VoIM client. The call-in telephone number may be any telephone number provided by the user. This may be a stored setting or option, or may be provided by the user prior to the call being made. The calling party uses the call-in telephone to call a VoIP gateway at a local access gateway number. The VoIP gateway has been instructed that an inbound call will be received from the call-in telephone number. When the inbound call from the call-in phone is received by the VoIP gateway, it routes the voice call to the called party at the destination identifier, as described above.

It will be appreciated to persons skilled in the art that various alterations, modifications and variations to the embodiments described herein may be effected. For example, while voice calls have been discussed primarily in the context of a caller or calling party and a single called party at the destination of the voice call, it will be appreciated that the teachings of the present disclosure may be adapted for use in conference calls with two or more called parties.

The foregoing detailed description of example embodiments of the present disclosure does not limit the implementation of the application to any particular computer programming language. The present disclosure may be implemented in any computer programming language provided that the operating system (OS) provides the facilities that may support the requirements of the present disclosure. An embodiment is implemented in the Java™ computer programming language (or other computer programming languages such as C or C++). (Java and all Java-based trademarks are the trademarks of Sun Microsystems Corporation.) Any limitations presented would be a result of a particular type of operating system or computer programming language and would not be a limitation of the present disclosure.

While the present disclosure is primarily described as a method, a person of ordinary skill in the art will understand that the present disclosure is also directed to apparatus such as a computer, a mobile communication device, and a server for carrying out at least some of the aspects and features of the described methods and including components for performing at least some of the described method steps, be it by way of hardware components, a computer programmed by appropriate software to enable the practice of the disclosed method, by any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the disclosed method. It is understood that such apparatus, articles of manufacture, and computer data signals also come within the scope of the present disclosure.

The embodiments of the present disclosure described above are intended to be examples only. Those of skill in the art may effect alterations, modifications and variations to the particular embodiments without departing from the intended scope of the present disclosure. In particular, features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole. The subject matter described herein and in the recited claims intends to cover and embrace all suitable changes in technology.

1. A method of generating dynamic contact information, comprising:
providing two or more contact sources each comprising contact information defined for one or more contacts;
generating a dynamic contact list comprising one or more electronic contact records with contact information from the contact sources in accordance with one or more rules for inclusion in the dynamic contact list, wherein the rules comprise one of both of a rule based on presence information of the contact and a rule based on location information of the contact; and
transmitting the dynamic contact list to a first computing device for display thereon.

2. The method of claim 1, wherein generating the dynamic contact list comprises:
determining contacts in the contact sources which match the rules for inclusion in the dynamic contact list; and
populating the dynamic contact list with electronic contact records for contacts which match the rules for inclusion in the dynamic contact list.

3. The method of claim 2, wherein the rule based on location information defines a predetermined proximity between locations of the respective contacts to a location of the first computing device for inclusion in the dynamic contact list.

4. The method of claim 3, wherein the rules comprise both a rule based on presence information of the contact and a rule based on location information of the contact, the rule based on presence information defining presence status of the respective contacts for inclusion in the dynamic contact list.

5. The method of claim 4, wherein the presence status is based on resource availability, time availability, resource cross-dependency, or combinations thereof.

6. The method of claim 4, further comprising displaying the dynamic contact list on a display screen of the first computing device, wherein presence information associated with electronic contact records in the dynamic contact list is presented together with the contact information of the electronic contact records on the display screen.

7. The method of claim 3, further comprising determining the location of the first computing device.

8. The method of claim 2, further comprising:
periodically updating the dynamic contact list at predetermined intervals, the periodical updating comprising:
determining if presence information or location information associated with the contacts in dynamic contact list has changed since the dynamic contact list was previously populated or updated;
if the presence information or location information has changed, updating the dynamic contact list by removing electronic contact records for contacts which do not match the rules for inclusion in the dynamic contact list, and adding electronic contact records for contacts which match the rules for inclusion in the dynamic contact list.

9. The method of claim 8, wherein periodically updating the dynamic contact list comprises:
determining if contact information in the contact sources corresponding to contacts in dynamic contact list has changed since the dynamic contact list was previously populated or updated;
if the contact information has changed, modifying the electronic contact records in the dynamic contact list for contacts having contact information which has changed to match the updated contact information in the contact sources.

10. The method of claim 1, wherein generating the dynamic contact list comprises:
determining contacts in the contact sources which match the rules for inclusion in the dynamic contact list; and
populating the dynamic contact list with electronic contact records for contacts from one or both of a personal contact list and an enterprise contact list; and
populating the dynamic contact list with electronic contact records for contacts with contact information from the contact sources in accordance with the rules for inclusion in the dynamic contact list, wherein electronic contact records are added to the dynamic contact list if one or a combination of presence or location information associated with the contacts match the rules.

11. The method of claim 10, wherein the contact sources comprise an Instant Messaging (IM) list of IM contacts and a third party contact list, the populating comprising adding electronic contact records to the dynamic contact list with contact information from the IM list and third party contact list, wherein the electronic contact records for IM contacts and third party contacts are added to the personal contact list and enterprise contact list in the dynamic contact list if one or a combination of presence or location information associated with the contacts match the rules.

12. The method of claim 1, wherein the rules comprise a rule based on one or both of the contacts and contact sources to be considered when determining to include a contact in the dynamic contact list.

13. The method of claim 12, wherein the rule based on one or both of the contacts and contact sources to be considered when determining to include a contact defines one or more of: contact sources, individual contacts, and groups of contacts which are to be considered.

14. The method of claim 1, wherein the rules comprise a rule based on priority of a relationship to the contact.

15. The method of claim 1, wherein the rules comprise a rule based on one or more of date and time of day.

16. The method of claim 1, wherein the rules comprise a rule based on calendar information, the rule defining a time period in which contacts associated with calendar entries are to be included in the dynamic contact list.

17. The method of claim 1, wherein the location information is determined from the contact information in the contact sources.

18. The method of claim 1, wherein the location information is provided by a location server providing location services, a Global Positioning System (GPS) or an assisted GPS.

19. The method of claim 1, wherein the contact sources comprise of: a personal contact list, an enterprise contact list associated with an enterprise network associated with the first computing device or user of the first computing device, an Instant Messaging (IM) list of IM contacts, and a third party contact list.

20. The method of claim 19, wherein the third party contact list is a list of service providers or merchants advertising their respective businesses in the third party contact list.

21. The method of claim 19, wherein the contact sources further comprise a Really Simple Syndication (RSS) document or feed.

22. The method of claim 2, further comprising:
receiving a search string;
determining contacts in the contact sources which match the rules for inclusion in the dynamic contact list and which include the search string in the contact information; and
populating the dynamic contact list with electronic contact records for contacts with contact information from the contact sources in accordance with the rules for inclusion in the dynamic contact list and which include the search string.

23. The method of claim 1, wherein the rules comprise a rule based on predefined preferences, the dynamic contact list being populated with electronic contact records for contacts having contact information which matches the rule based on predefined preferences.

24. The method of claim 23, wherein the predefined preferences are user, business preferences, or a combination thereof.

25. The method of claim 23, wherein the predefined preferences define a priority of a relationship to the contact.

26. The method of claim 1, further comprising receiving input selecting an electronic contact record in the dynamic contact list, and invoking a mapping application to display a map of the location of the contact specified in the selected electronic contact record on a display screen of the first computing device.

27. The method of claim 1, further comprising receiving input selecting an electronic contact record in the dynamic contact list, and invoking a mapping application to display directions from a current location of the first computing device to the location of the contact specified in the selected electronic contact record on a display screen of the first computing device.

28. The method of claim 27, further comprising determining the location of the first computing device.

29. The method of claim 1, wherein the electronic contact records of the dynamic contact list are logically grouped into classifications in accordance with information about the electronic contact records, the method further comprising displaying the dynamic contact list on a display screen of a first computing device, wherein the electronic contact records are presented within respective logical groupings.

30. The method of claim 29, wherein the logical groupings comprising personal contacts, internal resources and external resources.

31. The method of claim 29, wherein the logical groupings are displayed in a descending order of priority.

32. The method of claim 30, wherein the logical grouping of external resources comprise sub-groups of preferred contacts and other contacts, wherein contacts are displayed before other contacts descending order of priority within the logical grouping of external resources.

33. The method of claim 1, wherein the contact information included in the electronic contact records of the dynamic contact list is determined in accordance with predefined rules and preferences.

34. The method of claim 1, further comprising:
receiving instructions to initiate a communication with a contact in the dynamic contact list, the instructions comprising one or both of a destination identifier for the communication and a communication type,
wherein the destination identifier comprises one of a telephone number, an email address, an instant messaging (IM) address, and a session initiation protocol uniform resource indicator (SIP URI),
wherein the communication type is one of (1) a voice call to the telephone number, IM address or SIP URI, (2) an email message to the email address, (3) an IM message to the IM address, (4) an Short Message Service (SMS) message to the telephone number, and (5) an Multimedia Messaging Service (MMS) message to the telephone number; and
conducting the communication in accordance with the selected destination identifier and communication type.

35. A server configured to communicate with a plurality of computing devices over a communications network, comprising:
a processor; and
a communications subsystem connected to the processor for exchanging signals with the communications network and with the processor;
wherein the server is configured for:
collecting contact information from two or more contact sources of contact information;
generating a dynamic contact list comprising one or more electronic contact records with contact information from the contact sources in accordance with one or more rules for inclusion in the dynamic contact list, wherein the rules comprise one of both of a rule based on presence information of the contact and a rule based on location information of the contact; and
transmitting the dynamic contact list to a first computing device.

36. A computing device, comprising:
a processor for controlling the operation of the computing device;
a display screen connected to the processor; and
a communications subsystem connected to the processor for exchanging signals with the communications network and with the processor;
a input device connected to the processor for receiving input;
wherein the computing device is configured for:
receiving a dynamic contact list comprising one or more electronic contact records with contact information from the contact sources in accordance with one or more rules for inclusion in the dynamic contact list, wherein the rules comprise one of both of a rule based on presence information of the contact and a rule based on location information of the contact; and
displaying the dynamic contact list on the display screen.

37. The computing device of claim 36, wherein the computing device is further configured for:
receiving instructions to initiate communications with a contact in the dynamic contact list, the instructions comprising one or both of a destination identifier for the communications and a communication type,
wherein the destination identifier comprises one of a telephone number, an email address, an instant messaging (IM) address, and a session initiation protocol uniform resource indicator (SIP URI),
wherein the communication type is one of (1) a voice call to the telephone number, IM address or SIP URI, (2) an email message to the email address, (3) an IM message to the IM address, (4) an Short Message Service (SMS) message to the telephone number, and (5) an Multimedia Messaging Service (MMS) message to the telephone number; and
conducting the communications in accordance with the selected destination identifier and communication type.
